(19) United States
(12) Patent Application Publication
(10) Pub. No.: US 2020/0042160 A1
(43) Pub. Date: Feb. 6, 2020

(54) System and Method for Providing Virtual-Reality Based Interactive Archives for Therapeutic Interventions, Interactions and Support

(71) Applicants: Alessandro Gabbi, Austin, TX (US); Mark Harrison, Austin, TX (US)

(72) Inventors: Alessandro Gabbi, Austin, TX (US); Mark Harrison, Austin, TX (US)

(21) Appl. No.: 16/445,196

(22) Filed: Jun. 18, 2019

Related U.S. Application Data
(60) Provisional application No. 62/686,188, filed on Jun. 18, 2018.

(51) Int. Cl. G06F 3/0484; G06F 3/0486; G06F 3/0482

(52) U.S. Cl. CPC G06F 3/04847; G06F 3/04845; G06F 3/0482; G06F 3/0486

(57) ABSTRACT

A system and methods for providing virtual computer-generated interactive archives, activities, illness education for therapeutic support and legacy building via storyboards. The therapeutic support and legacy building can be provided to a variety of individuals, such as those dying or seriously ill, the elderly, and respective family members, friends, and loved ones. In some examples, the system and methods disclosed herein provide a therapeutic solution for anticipatory grief and a virtual reality model for family legacy building. In other cases, the systems and methods disclosed may also provide solutions for the implementation of activities related to coping or illness education.

### CROSS REFERENCE TO RELATED PATENT APPLICATIONS

This patent application claims priority to U.S. provisional patent application 62/686,188, filed on Jun. 18, 2018, entitled Method and System for Providing Virtual-Reality Based Interactive Archives, by inventors Alessandro Gabbi and Mark Harrison, the disclosure of which is incorporated herein in its entirety.

### BACKGROUND

The disclosures herein relate generally to an electronic system and method that provides therapeutic support for individuals.

### BRIEF SUMMARY

In one embodiment, a method is disclosed for creating VR-based interactive archives for therapeutic support using the system includes accessing the support system through a user account, wherein each user account may be associated with an avatar. The method also includes constructing a virtual realty environment in the support system by first selecting a type of setting. The method further includes building a room environment for therapy purposes by dragging and dropping selectable items. The method still further includes creating or dragging-and-dropping various forms of selectable content in the virtual reality environment. If the selected content in the support system is associated with a specific condition, then the method enables tagging the content with specific conditions, such as a geolocation tag. The disclosed method also includes setting time limits for activities using dependency controls. The method can also include artificial intelligence extensions in the virtual reality environment of the support system to enable the system to learn from user input and to change the virtual reality environment in response to such learning.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 is a high-level block diagram showing a system that enables users to create their own virtual reality-based environments through storyboards;

FIG. 2 is a flow chart illustrating an exemplary method of creating virtual reality (VR) based, interactive archives for therapeutic support using the system of FIG. 1;

FIG. 3 is a flow chart illustrating another exemplary method of creating VR-based, interactive archives for legacy building using the system of FIG. 1;

FIG. 4 is a graphical user interface drawing illustrating an example GUI of settings that a user may select from for constructing the user's VR environment in the system of FIG. 1;

FIG. 5 is a graphical user interface drawing illustrating an exemplary GUI of drag and drop items that may be selected and placed in a therapeutic room of the system of FIG. 1;

FIG. 6 is a graphical user interface drawing illustrating an example GUI of a digital photo album with audible picture-specific memories and stories; and

FIG. 7 is a graphical user interface drawing illustrating an example GUI of a user computing device including a geolocation tag associated with a specific memory.

FIG. 8 is a more-detailed block diagram of a user information handling system that can be employed as the user computing device in the system of FIG. 1.

FIG. 9 is a more-detailed block diagram of a server information handling system (IHS) that can be employed as the server of FIG. 1.

FIG. 10 is a representative login screen used by the user computing device of the disclosed system.

FIG. 11 is an alternative login screen that may be used by the user computing device of the disclosed system.

FIG. 12 is a representative enter personal data screen used by the user computing device of the disclosed system.

FIG. 13 is a representative “therapist—create client profile” screen used by the user computing device of the disclosed system.

FIG. 14 is a representative therapist home screen used by the user computing device of the disclosed system.

FIG. 15 is a representative “therapist—manage activities” screen used by the user computing device of the disclosed system.

FIG. 16 is a representative “therapist—manage clients” screen used by the user computing device of the disclosed system.

FIG. 17 is a representative “therapist—manage widgets” screen used by the user computing device of the disclosed system.

FIG. 18 is a representative “client—create avatar” screen used by the user computing device of the disclosed system.

FIG. 19 is a representative “client—create/configure activities” screen used by the user computing device of the disclosed system.

FIG. 20 is a representative “client—create/configure waiting room screen with point example” screen used by the user computing device of the disclosed system.

FIG. 21 is a representative “client—home” screen used by the user computing device of the disclosed system.

FIG. 22 is a representative “client—interactive archive” screen used by the user computing device of the disclosed system.

FIG. 23 is a representative “client—activities with geo-condition” screen used by the user computing device of the disclosed system.

FIG. 24 is a representative “client—activities (therapeutic game)” screen used by the user computing device of the disclosed system.

FIG. 25 is a representative “client—activities (self-care check)” screen used by the user computing device of the disclosed system.

FIG. 26 is a representative “client-activities (legacy building with locking/unlocking)” screen used by the user computing device of the disclosed system.

FIG. 27 is a representative view of one embodiment of the disclosed system hardware.

FIG. 28 is a representation of the database in the support system in the server of the disclosed system.

FIG. 29 is a representation of the cloud-based service that provides provisioning to the server of the disclosed system.

FIG. 30 is a representative view of another embodiment of the disclosed system hardware.

FIG. 31 is a representation of multiple modules employed by the disclosed system.

FIG. 32 is a representation of multiple virtual reality applications employed by the disclosed system.

FIG. 33A is a representation of activities and characteristics of activities such as locked/unlocked activities, conditional activities, public activities and private activities that one embodiment of the disclosed system employs.

FIG. 33B is a representation of public and private widgets included in one embodiment of the disclosed system.

FIG. 34A is a flowchart that describes a representative process flow for activities in the disclosed system.

FIG. 34B is a flowchart that describes a representative process flow for widgets in one embodiment of the disclosed system.

FIG. 35 is a flowchart that describes a representative process flow for a therapist's typical interaction with one embodiment of the disclosed system.

FIG. 36 is a flowchart that describes a representative process flow for a patent user's or client user's typical interaction with one embodiment of the disclosed system.

### DETAILED DESCRIPTION

As elderly individuals age, their family members continuously look for ways to preserve their experiences, memories, and family legacy. In addition, individuals often deal with situations where a member of the family has a terminal or life-threating illness and the family members are aware that there may be limited time left for the dying individual. A type of grief counseling known as anticipatory grief helps patients and loved ones prepare for the moment. Examples of anticipatory grief counseling involve playing prerecorded videos of a dying parent at key moments in their child's life and preparing memory boxes with important mementos/letters that can be read during special circumstances. These activities provide therapeutic support to the family and patient by allowing for closure. Most of these activities are currently performed without therapeutic supervision (or any supervision) and are rarely digitally preserved.

Some current methods and systems for preserving experiences, memories, and family legacies have many deficiencies and problems. Specifically, they are often limited to the creation of photo albums, documents, or video interviews of certain individuals. These systems and methods though are not immersive or experiential for their users. A much closer legacy building experience for family members may be achieved through audio and visual digital representations of the deceased individual as a part of an interactive archive. Similarly, common therapeutic interventions and activities to assist with coping with illness or death are constrained by the need of the patient or client to be directly present on site with the therapist. A much more thorough and flexible therapeutic experience can be accomplished through immersion in activities via virtual reality as disclosed herein.

Accordingly, there exists a need for a system and method that can provide a therapeutic solution to help with anticipatory grief, illness education, coping, and legacy-building, while also providing a digital archive adapted to preserve the experiences, memories and family legacies of individuals directly impacted by illness or death. In one embodiment, a system and method are disclosed that provide virtual computer-generated interactive archives for therapeutic interventions, interactions, support and/or legacy building via storyboards. Using the disclosed technology, therapeutic support and legacy building can be provided to a variety of individuals, such as those dying or seriously ill, the elderly, and respective family members, friends, and loved ones. In some examples, the system and methods disclosed herein provide a therapeutic solution for anticipatory grief and a virtual reality model for family legacy building.

In a representative embodiment, a virtual-reality (VR) based interactive archive system is provided to allow users to create their own VR-based archives through storyboards and/or other assistive content creation tools. The disclosed VR interactive archive system can include a support system that renders a VR environment viewable by the user. The support system can also manage changes to the VR environment that result from the participation and interaction of users and certified professionals in the VR environment. Users may access the support system from a web user based application (or app) or a web portal that includes a graphical user interface (GUI) adapted for display upon a user computing device.

The support system includes a server that communicates data with one or more users of user computing devices coupled together via a network. The server can be any computing device and can include one or more processors, memory, permanent storage, I/O interfaces and virtual reality display. This server is capable of web-based or other remote communication with user computing devices coupled thereto. The server may be in local and/or remote communications with one or more repositories and/or databases, which store data for the support system to be provided to the users over the network.

In one representative embodiment, the disclosed method of creating VR-based interactive archives for therapeutic support using the system includes accessing the support system through a user account, wherein each user account may be associated with an avatar. The method also includes constructing a virtual realty environment in the support system by first selecting a type of setting. The method further includes building a room environment for therapy purposes by dragging and dropping selectable items. The method still further includes creating or dragging-and-dropping various forms of selectable content in the virtual reality environment. If the selected content in the support system is associated with a specific condition, then the method enables tagging the content with specific conditions, such as a geolocation tag. The disclosed method also includes setting time limits for activities using dependency controls. The method can also include artificial intelligence extensions in the virtual reality environment of the support system to enable the system to learn from user input and to change the virtual reality environment in response to such learning.

In another representative embodiment, the disclosed method of creating VR-based, interactive archives for legacy building and therapeutic support includes the user accessing the support system through a user account, wherein each user account may be associated with an avatar. The method also includes constructing a virtual realty environment in the support system by first selecting a type of setting. The method further includes creating or dragging-and-dropping selectable forms of content in the virtual reality environment. If the selected or created content in the support system is associated with a specific condition, then this content can be tagged with specific conditions, such as a geolocation tag. The method also includes setting time limits for activities within the virtual reality environments by using dependency controls. The method further includes incorporating artificial intelligence extensions in the virtual reality environment of the support system. The method still further includes providing configurable quests to users, via the support system, for discovery of family histories. The configurable quests may be defined solely in the VR environment or in a combination of the VR environment and in real word quests that the user can complete to unlock content in that user's virtual reality environment.

In this Detailed Description, numerous specific details are set forth in order to provide a thorough understanding of the examples as defined in the claimed subject matter, and as an example of how to make and use the examples described herein. However, it will be understood by those skilled in the art that claimed subject matter is not intended to be limited to such specific details, and may even be practiced without requiring such specific details. In other instances, well-known methods, procedures, and components have not been described in detail so as not to obscure the examples defined by the claimed subject matter.

Some portions of the detailed description that follow are presented in terms of algorithms and/or symbolic representations of operations on data bits and/or binary digital signals stored within a computing system, such as within a computer and/or computing system memory. An algorithm is here and generally considered to be a self-consistent sequence of operations and/or similar processing leading to a desired result. The operations and/or processing may take the form of electrical and/or magnetic signals configured to be stored, transferred, combined, compared and/or otherwise manipulated. It has proven convenient at times, principally for reasons of common usage, to refer to these signals as bits, data, values, elements, symbols, characters, terms, numbers, numerals and/or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing”, “computing”, “calculating”, “determining” and/or the like refer to the actions and/or processes of a computing platform, such as a computer, mobile computing device, smart phone or a similar electronic computing device that manipulates and/or transforms data represented as physical electronic and/or magnetic quantities and/or other physical quantities within the computing platform's processors, memories, registers, and/or other information storage, transmission, and/or display devices.

Unless specifically stated otherwise, as apparent from the following discussion, it is appreciated that throughout this specification a computing platform includes, but is not limited to, a device such as a computer or a similar electronic computing device that manipulates and/or transforms data represented by physical, electronic, and/or magnetic quantities and/or other physical quantities within the computing platform's processors, memories, registers, and/or other information storage, transmission, reception and/or display devices. Accordingly, a computing platform refers to a system, a device, and/or a logical construct that includes the ability to process and/or store data in the form of signals. Thus, a computing platform, in this context, may comprise hardware, software, firmware and/or any combination thereof. Where it is described that a user instructs a computing platform to perform a certain action, it is understood that “instructs” may mean to direct or cause to perform a task as a result of a selection or action by a user. A user may, for example, instruct a computing platform embark upon a course of action via an indication of a selection, including, for example, pushing a key, clicking a mouse, maneuvering a pointer, touching a touch pad, touching a touch screen, acting out touch screen gesturing movements, maneuvering an electronic pen device over a screen, verbalizing voice commands, and/or by audible sounds. A user may include an end-user.

Flowcharts, also referred to as flow diagrams by some, are used in some figures herein to illustrate certain aspects of some examples. Logic they illustrate is not intended to be exhaustive of any, all, or even most possibilities. Their purpose is to help facilitate an understanding of this disclosure with regard to the particular matters disclosed herein. To this end, many well-known techniques and design choices are not repeated herein so as not to obscure the teachings of this disclosure.

Throughout this specification, the term “system” may, depending at least in part upon the particular context, be understood to include any method, process, apparatus, and/or other patentable subject matter that implements the subject matter disclosed herein. The subject matter described herein may be implemented in software, in combination with hardware and/or firmware. For example, the subject matter described herein may be implemented in software executed by a hardware processor.

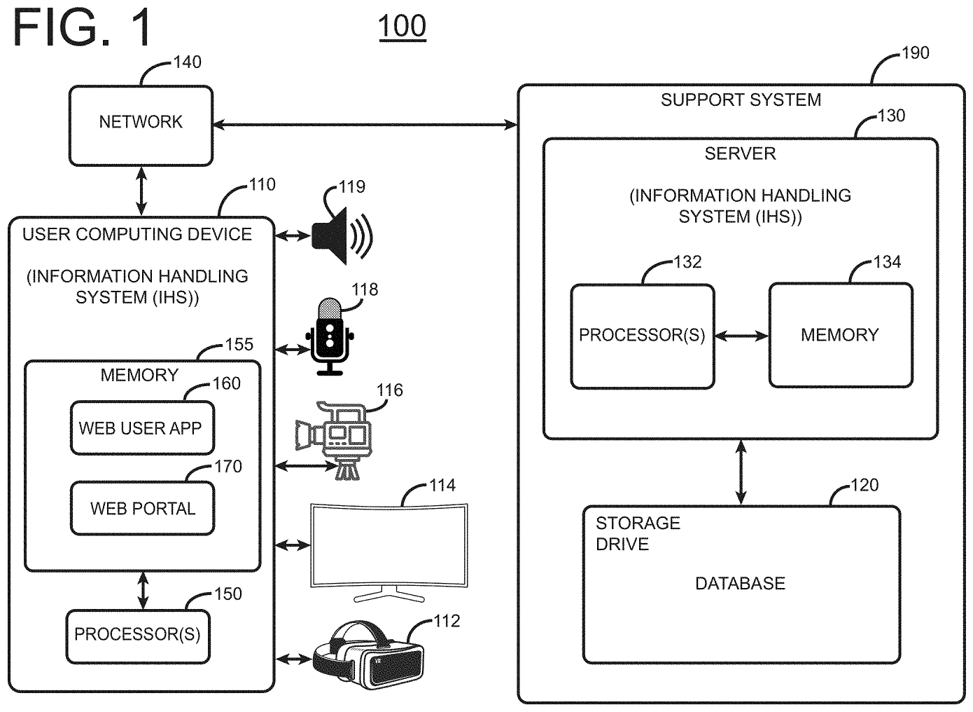

FIG. 1 is a high-level block diagram showing a system 100 that enables users to create their own virtual reality-based (VR-based) environments and interactive archives through storyboards in one embodiment. System 100 includes a support system 190 that may be used for various types of activities, including, but not limited to providing therapeutic support, illness education and activities and/or legacy building for dying or seriously ill individuals, elderly, and their respective family members, friends, and loved ones.

Users have the opportunity to receive the support and guidance of certified professionals associated with support system 190, such as therapists and legacy builders, when creating their own VR-based environments in support system 190. Support system 190 is capable of rendering a VR environment and managing changes to the VR environment resulting from the participation and interaction of users and certified professionals in the VR environment.

Users may access the support system 190 from a web user based application (or app) 160 or a web portal 170 that has a graphical user interface (GUI) adapted for display upon a user computing device 110. The web portal 170 may be viewable with a standard web browser, such as Internet Explorer®, Mozilla®, Safari® and/or Chrome®. The web user app 160 may access the support system 190 by a user computing device 110, such as but not limited to, mobile devices, tablets, desktop or laptop computers, mobile phones, and others known in the art.

User computing device 110 is coupled to support system 190 via a network 140 such as the Internet, a local area network (LAN), and/or wide area network (WAN). Advantageously, when the Internet is employed as network 140, the user of user computing device 110 may access support system 190 remotely and while mobile.

In some embodiments, user computing device 110 may access support system 190 via a virtual reality (VR) headset 112. Examples of some of the types of VR headsets that may be used include, but are not limited to Google Cardboard®, Google Daydream®, Oculus VR®, and any equipment in the Windows Mixed Reality ecosystem.

User computing device 110 includes one or more processors 150, each including one or more cores. Processor 150 couples to memory 155 which may be system memory or memory store in which applications and instructions can be stored for execution. For example, memory 155 stores web user app 160 and web portal 170.

In addition to VR headset 112, or instead of VR headset 112, user computing device 110 may couple to a large screen curved-screen display 114 that is sufficiently large to provide an at least partially immersive environment to the user However, a true VR display device such as VR headset 112 is preferred. Optionally, user computing device 110 may be coupled to a video camera 116 for recording user video to aid in legacy creation, and may be further coupled to a microphone 118 for recording user audio to aid in legacy creation. Recorded video and audio may be output to selectable combinations of VR headset 112, large screen display 114 and loudspeaker 119.

As further seen in FIG. 1, support system 190 includes a server 130 that communicates data with one or more users of user computing device over a network 140. Network 140 may include, for example, Internet networks, cellular networks, local area networks, wireless networks, Ethernet networks, and combinations thereof. It is noted that at any particular point in time, support system 190 may be communicated with multiple users of multiple user computing devices 110.

Server 130 can be any computing device and can include one or more processors 132 and/or memory 134 and is capable of web-based or other remote communication with user computing devices 110. The processor 132 of the server 130 may be capable of executing electronically stored instructions to perform one or more methods described herein. Server 130 may be in local and/or remote communications with one or more repositories and/or databases 120 that are part of support system 190. Databases 120 store data for the support system 190 to be provided to the users over network 140. In some examples, the data are stored in a so-called “cloud” using third-party services. A “cloud” refers to a collection of data and resources (e.g., hardware, data and/or software) provided and maintained by an off-site or off-premise party (e.g., third party), wherein the collection of data and resources can be accessed by an identified user via a network. In one embodiment, a “cloud” may allow for the storage and preservation of an entire family's legacy.

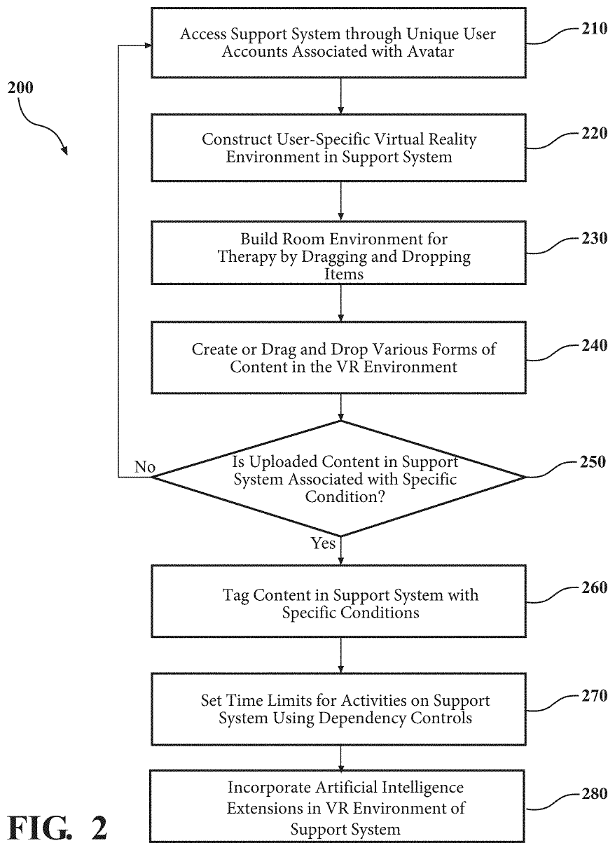

FIG. 2 shows a flow chart that illustrates an exemplary method 200 of creating VR-based, interactive archives for therapeutic support using system 100 of FIG. 1. As shown in block 210, users obtain access by logging into the support system 190 through their unique user accounts. Users may access the support system 190 through the app 160, the web portal 170, or the VR headset.

Each of the user accounts may be associated with one or more avatars, which each user may select for appearing in a VR environment. Support system 190 may restrict users to a single avatar, may maintain multiple avatars, or may allow users to navigate through a VR environment as observers with no avatars. The VR environments represent a virtual spaces in which avatars may interact. Each virtual environment may have a VR-based archive that may be operated by different users and/or certified professionals.

Once users have logged into their user accounts in support system 190, they can view their user profiles, which show the activities currently available. Activities that are not currently available are displayed as “locked.” In some examples, other activities are not visible until certain conditions are met. In the therapeutic mode of the support system 190, a user may be awarded points (determined by the certified professionals) for completing various activities.

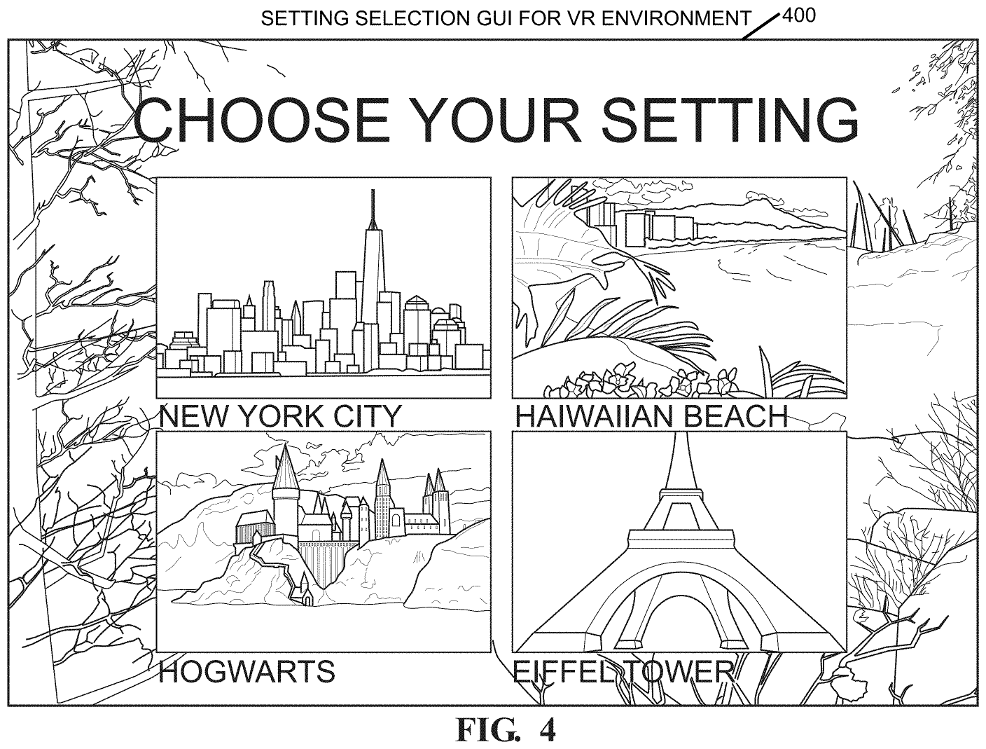

Next, users begin constructing their own VR environments in support system 190 using a setting creator tool by first selecting a setting from a list of settings, as shown in block 220. The settings may represent a real place, such as New York City, a Hawaiian beach, or the Eiffel Tower; licensed content templates, such as Hogwarts and Middle Earth; or a complete terraforming environment where users can create their own worlds, as shown in FIG. 4. FIG. 4 shows an example GUI 400 of settings that a user may select from for constructing the user's VR environment. A setting may be defined by various attributes such as appearance, size, architecture, for example. When creating terraforming environments, user creation of 3D graphic widgets is attributed with configurable logic.

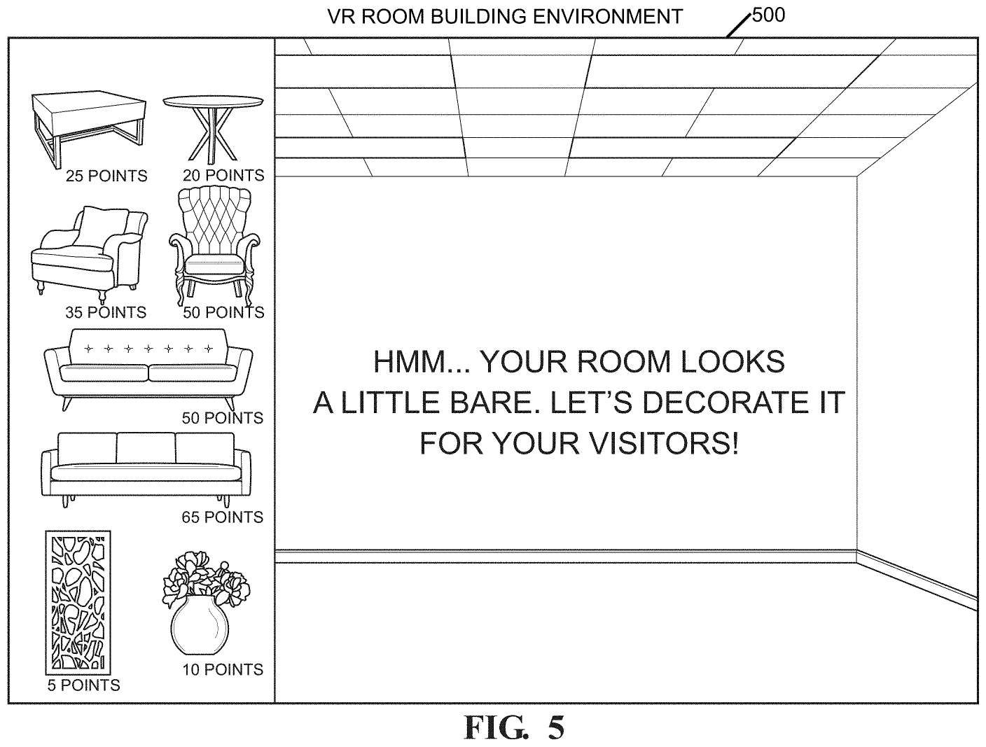

As shown in block 230, support system 190 displays a room-building environment/GUI 500 for users to drag-and-drop items in the room to create a comfortable setting for the users. Examples of some of the drag-and-drop items, such as couches, chairs, vases, and tables, can be found in FIG. 5. FIG. 5 shows an example GUI 500 of drag and drop items that may be placed in a therapeutic room of the system of FIG. 1. In some examples, users can participate in interactive games/activities within a VR environment, such as petting a dog, opening an envelope, or touching a painting. Users are rewarded points for dragging-and-dropping items in the room and for participating in the games/activities within the VR environment.

Next, as shown in block 240, users are able to either create or drag-and-drop various forms of content in the support system 190. Ready-made therapeutic widgets/activities centered on illness education or coping, are provided that can be drag and dropped into the VR environments generated by the users. Users are able to drag and drop joint/interactive activities templates.

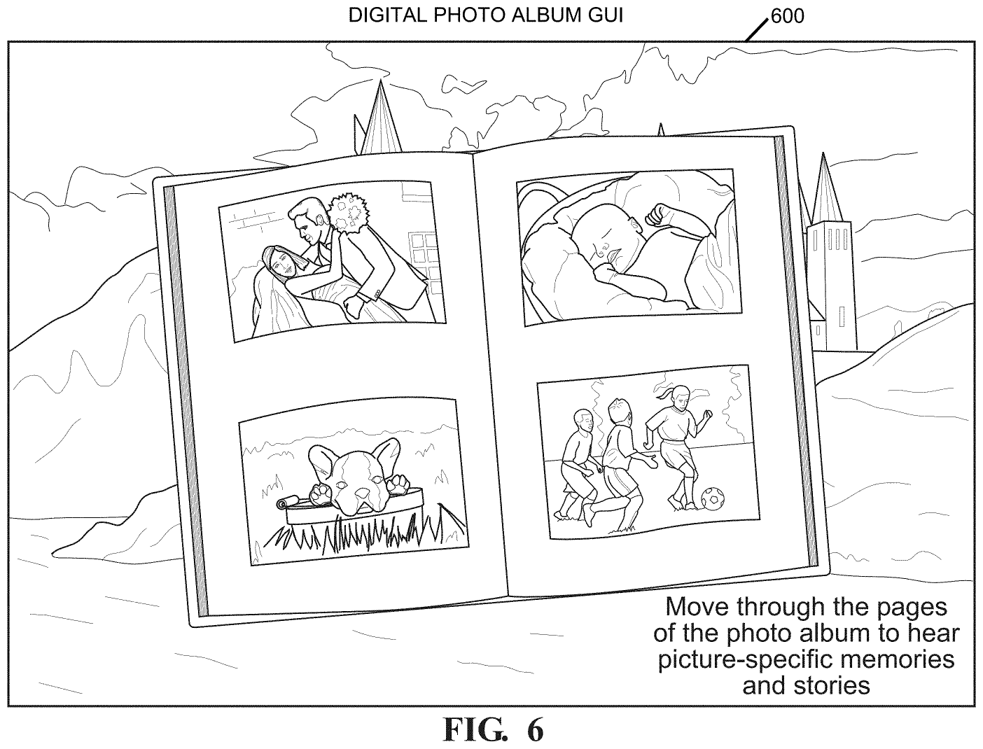

Users are also able to upload a variety of multi-format content, such as VR, video, images, and audio, to the relevant pages in the support system 190. These graphic widgets can be static or dynamic. FIG. 6 shows an example GUI 600 for moving through pages of a digital photo album to hear picture-specific memories and stories. In some examples, users build and define complex widgets that can either be uploaded as independent code using an API or through a configuration engine found in the support system 190. The API allows for the ability to integrate with other currently available products.

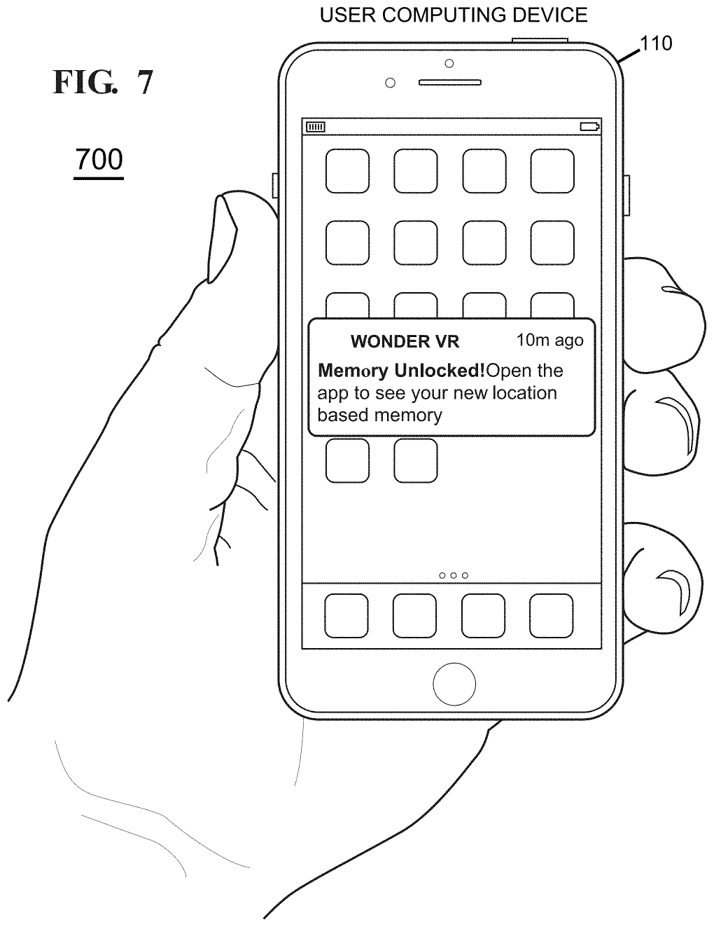

As shown in block 250, the widgets uploaded into the support system 190 by users only make content available based on various complex conditions. Any activity loaded into the support system 190 may be tagged with various conditions before it unlocks, as shown in block 260. An exemplary condition includes a real-world geolocation tag, where a user will only be able to access a particular activity, such as a memory, when the user is located in a particular location, as shown in FIG. 7. FIG. 7 shows an example GUI 700 of the user computing device 110 including a geolocation tag associated with a specific memory. Other examples of conditions include time, date, age of the users, completion of other activities, and achievement of a certain point threshold, illness or type, and other clinical criteria. In an alternative embodiment, another block is provided between block 250 and 260 wherein the “User Accesses Activities Related to Therapy & Illness Education” based on therapeutic needs.

In some examples, users of support system 190 have the ability to make any of their activities or widgets publicly available to the rest of the users of the support system 190 or to a smaller subset of users thereof. If these activities are geographically based, they may display as pins on a map. The support system 190 is also configured to display certain activities in augmented reality based on geolocation using either Bluetooth, Wi-Fi, or GPS.

In some examples, support system 190 is configured to provide dependency controls to set time limits for activities on the support system 190, as shown at block 270. The limits are configurable and may curtail a user's access to the support system 190.

In some examples, the therapeutic widgets included in the VR environment of the support system 190 require user participation to complete, along with artificial intelligence to ensure proper use of the relevant widgets. As shown in block 280, various artificial intelligence extensions may be used, such as advanced voice command and natural language interface (e.g. Alexa). Artificial intelligence also allows for the ability to provide additional interactions with digital representations of the deceased via chat, text, voice, and the like. For example, both a voice and an avatar may be “skinned” to create a three-dimensional digital representation of the deceased as an avatar.

Activity-based widgets in the support system 190 provide users and certified professionals with ready-made templates that allow for rapid deployment, upload, and use of information for the purposes described herein. Examples of therapeutic, activity-based widgets include, but are not limited to, quizlets/assessments, interactive games, static, multi-format content, shared experiences, conditional configurations, and point configurations.

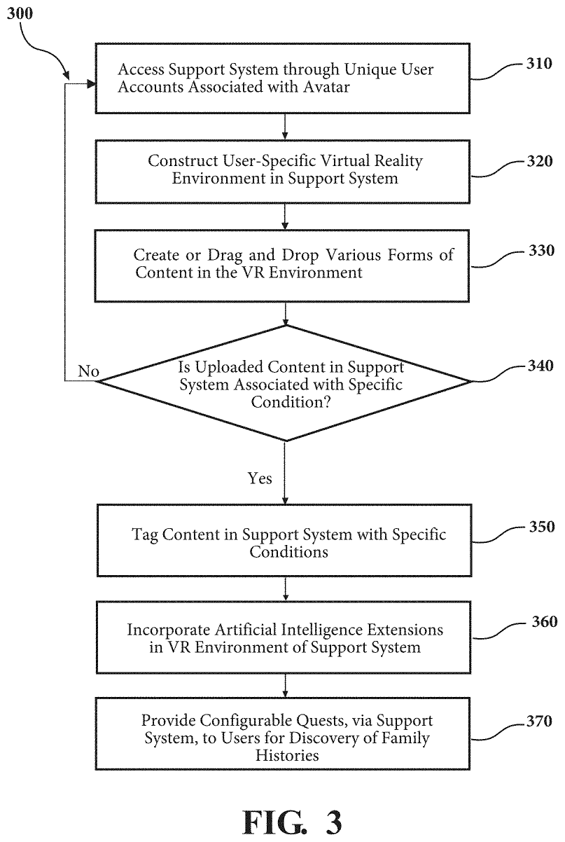

FIG. 3 is a flow chart that illustrates an exemplary method 300 of creating VR-based, interactive archives for legacy building using the system 100 of FIG. 1. The flowchart of FIG. 3 includes some steps that are in common with the flowchart of FIG. 2 that was discussed above. As shown in block 310, users obtain access by logging into the support system 190 through their unique user accounts. Users may access the support system 190 through the app 160, the web portal 170, or the VR headset.

Once users have logged into their user accounts in the support system 190, they can view their user profiles, which show the activities currently available. Activities that are not currently available are displayed as “locked.” In some examples, other activities are not visible until certain conditions are met.

Next, users begin constructing their own VR environments in the support system 190 by first selecting a setting from a list of settings, as shown in block 320. The settings may be a real place, such as New York City, a Hawaiian beach, or the Eiffel Tower; licensed content templates, such as Hogwarts and Middle Earth; or a complete terraforming environment where users can create their own worlds, as shown in FIG. 4. When creating terraforming environments, the configurable, 3D widgets are capable of using complex logic to determine behavior. For example, support system 190 can be configured to show a video of a user's mother when the user is within 100 feet of her grave.

Next, as shown in block 330, users are able to either create or drag-and-drop various forms of content in the support system 190. Ready-made legacy building widgets/activities are provided that can be drag and dropped into the VR environments generated by the users. Users are able to drag and drop joint/interactive activities templates. Legacy building specifically involves the dynamic uploading and insertion of renditions from the real world, such as skins/avatars, pictures, video segments, and interactive content.

Users are also able to upload a variety of multi-format content, such as VR, video, images, and audio, to the relevant pages in the support system 100. These graphic widgets can be static or dynamic. FIG. 6 shows a graphical user interface drawing illustrating an example GUI for moving through pages of a digital photo album to hear picture-specific memories and stories. In some examples, users build and define complex widgets that can either be uploaded as independent code using an API or through a configuration engine found in the support system 190.

As shown in block 340, the widgets uploaded into the support system 190 by users only make content available based on various complex conditions. Any activity loaded into the support system 190 may be tagged with various conditions before it unlocks, as shown in block 350. An exemplary condition includes a real-world geolocation tag, where a user will only be able to access a particular activity, such as a memory, when the user is located in a particular location, as shown in FIG. 7. Other examples of conditions include time, date, age of the users, completion of other activities, and achievement of a certain point threshold.

In some examples, users of support system 190 have the ability to make any of their activities or widgets publicly available to the rest of the users of the support system 190 or to a smaller subset of users thereof. If these activities are geographically based, they may display as pins on a map. The support system 190 is also configured to display certain activities in augmented reality based on geolocation using either Bluetooth, Wi-Fi, or GPS and to have interactions with digital projections of all family members in pre-defined constructs. For example, users may be in a VR environment that has a digital projection of a deceased grandfather telling stories around a campfire.

In some examples, the legacy building widgets included in the VR environment of the support system 190 require user participation to complete, along with artificial intelligence to ensure proper use of the relevant widgets. As shown in block 360, various artificial intelligence extensions may be used, such as advanced voice command and natural language interface (e.g. Alexa). Artificial intelligence also allows for the ability to provide additional interactions with digital representations of the deceased via chat, text, voice, and the like. For example, both a voice and an avatar may be “skinned” to create a three-dimensional digital representation of the deceased as an avatar.

In some embodiments of the method 300, the widgets included within the support system 190 by the users are interactive. An example involves photo albums having pictures that can animate and tell stories of the deceased individual.

Block 370 illustrates that users compete in configurable quests on the support system 190 to discover more information about their family histories. The configurable quests may be defined solely in the VR environment or in a combination of the VR environment and in real word quests that user can complete to unlock content in their VR environment. An example is a user visiting his deceased mother's five favorite places and uploading videos of his experience in each place to unlock a personalized video from her about those specific places. In some examples, integrated common aspects of gaming platforms, such as leaderboards and social sharing, may be included in the quests.

Activity-based widgets in the support system 190 provide users and certified professionals with ready-made templates that allow for rapid deployment, upload, and use of information for the purposes described in the present application. Examples of legacy building, activity-based widgets include, but are not limited to interactive games, static, multi-format games, shared experiences, conditional configuration, point configuration, and avatar creation and upload

In one embodiment, a user such as a patient user or a client user takes head-mounted VR display 112 and installs display 112 on his or head. In this manner, the user experiences the virtual reality environment presented by system 100. For example, system 100 may output a VR image to display 112 that presents the user with an activity such as, “Welcome to your coping activity for today. Some people find this simple breathing exercise to be a great way to relax after a particularly stressful day. Say “go” or point at my chest to get started.”

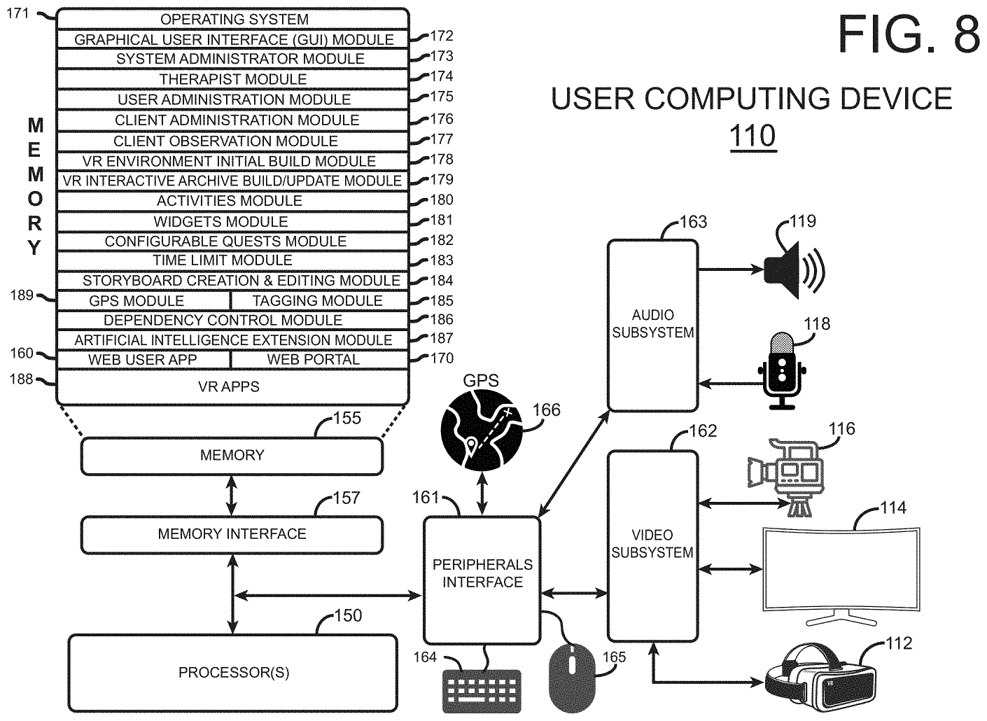

FIG. 8 is a more detailed block diagram of user computing device 110 of FIG. 1. Processor 150 is coupled to memory 155 via memory interface 157. A peripherals interface 161 couples process 150 to peripherals and to video subsystem 162 and audio subsystem 163. VR headset 112, large screen display 114 and video camera 116 are coupled to video subsystem 162. When user computing device 110 is a mobile device such as a smart phone, video camera 116 may be implemented as a small camera that is integrated within the mobile device. Microphone 118 and loudspeaker 119 are coupled to audio subsystem 163 provide audio input and audio output to user computing device 110. VR headset 112, video camera 116 and microphone 118 facilitate recording of memories and other events for legacy building and creation of the interactive VR archive. Keyboard 164 and mouse 165 couple to peripherals interface 161 to provide other user input to user computing device 110. GPS 166 is coupled to peripherals interface 161 to inform and update user computing device 110 with respect to the current location of user computing device 110.

In user computing device 110, memory 155 stores an operating system 171 such as Microsoft Windows®, Mac OS® or Linux® when user computing device 110 is implemented as a desktop computing device. When user computing device 110 is implemented as a portable computing device such as a smart phone, operating systems such as iOS® or Android® may be employed as operating system 171.

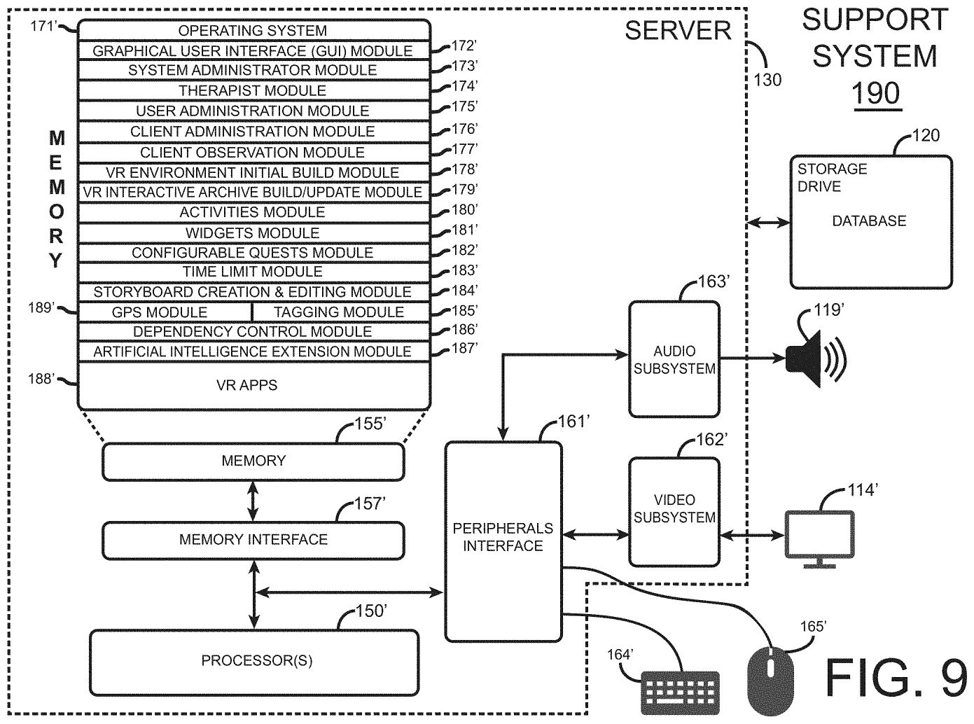

As seen in FIG. 8, memory 155 stores several modules that assist in carrying out legacy building and therapeutic patient treatment. In one embodiment these modules are stored locally in memory 155 within user computing device 110 as shown. In this manner, these modules may be executing locally in computing device 110 for the user. However, in a preferred embodiment shown in FIG. 9, these modules are stored within support system 190 and are accessed by user computing device 110 over network 140 by using web port 170 and web user app 160, as discussed in more detail below.

Returning to FIG. 8, memory 155 stores a graphical user interface (GUI) module 172 that controls the appearance to the user of the many screens disclosed herein and detailed throughout the drawings. Memory 155 also stores a system administrator module 172 that facilitates an Information Technology (IT) administrator, or person of similar capacity, to control the overall configuration and maintenance of system 100 as a whole. Memory 155 also stores as therapist module 174 that enables the therapist, e.g. certified professional, to control setup and operation of the system 100 to help patients as discussed below in more detail.

The typical users of system 100 include, but are not limited to:
Patients (for therapy)
Clients (for legacy building)
Clinicians/Therapeutic Professionals
System Administrators

Memory 155 also stores user administration module 175 and client administration module 176. The user of user administration module 175 is typically a client or patient, namely a person who is interacting with system 100 for the purpose of therapy or legacy building. Clients and patients are both users of system 100. Client users typically use system 100 for legacy building and patient users use system 100 to receive therapy. The user of client administration module 176 is typically a clinician/therapeutic professional such as a child life specialist, psychologist or social worker. These users employ system 100 to work with one or more patients, maintain records, and configure activities for each of their clients/patients independently. Memory 155 also stores client observation module 177 through which the clinician/therapeutic professional may observe the client's or patient's activities on system 100.

Memory 155 also stores a VR environment initial build module 178 that assists the patient or client in setting up this user's particular VR environment by constructing a virtual realty environment in the support system. For example, VR environment initial build module 178 allows the patient or client to first selecting a type of setting. Module 179 also allows the patient user to build a room environment for therapy purposes by dragging and dropping selectable items. Module 179 also allows the patient user to create or drag-and-drop various forms of selectable content in the virtual reality environment. Memory 155 also stores a VR interactive archive build/update module 179 the builds a VR interactive archive of information derived from the patient user or client user as they perform activities while they use system 100 for therapeutic or legacy building purposes.

Memory 155 also stores an activities module 180 that presents to the patient user or client user with interactive tasks to provide therapeutic support, illness education to provide therapy and/or legacy building for dying or seriously ill individuals, elderly, and their family members, friends, and loved ones. Memory 155 further stores a widgets module 181 that provides preconfigured items for use in the system, such as a pre-designed furniture item for use in the waiting room environment or ready-to-use avatars for use in avatar design.

Memory 155 also stores a configurable quests module 182 that presents to the patient user or client user game-like challenges that may award points for meeting a challenge or goal that the quest provides. Configurable quests are used by system 100 to discover and store family histories derived from the user's participation in the quest. One example of a configurable quest would involve the therapist designing a series of coping activities for completion by the patient. Each activity in the quest would only be unlocked and made available once prior activities had been completed successfully. A second example of a configurable quest would involve unlocking access to pictures in a legacy album. For example, a client might only be able to unlock a video message from a deceased relative after unlocking three geo-located memories in different locations.

Memory 155 further stores a time limits module 183 that sets time limits for activities within the VR environment using dependency controls. Time limits module monitors the amount of time that the user is consuming to perform a particular activity. If this time limit is exceeded, then time limits module 183 may curtail or otherwise modify access of the particular user to system 100. For example, a therapist or may choose to limit the amount of time that a patient can spend within a specific activity such as viewing the photo album of a deceased loved one. In a different example, a therapist may choose to limit the number of attempts that a patient can have with a particular activity, such as limiting the number of times a patient can complete an anger management coping exercise. Time limit module 183 operates in communication with, and in cooperation with, dependency control module 186 to control or limit use of system 100 by the user.

Memory 155 further stores a storyboard creation and editing module 184 that allows the user to create their own virtual reality-based environments by presenting the user with a storyboard of content derived from user activities in which the user participates while using system 100. Using the virtual reality storyboard, the user can input additional content to the storyboard and rearrange the content of the storyboard to control the presentation for viewing by the current user and potential future users.

Memory 155 also stores a GPS module 189 that reads and stores the current location of user computing device 110 as received from GPS 166. In this manner, as part of legacy building, system 100 receives content from the user describing an event that is currently happening and associates that event information with the location where that event is took place. In more detail, memory 155 further stores a tagging module 185 that communicates with GPS module 189 to tag content with specific conditions such as a geolocation tag. In other words, if selected content in the support system is associated with a specific condition, then the method enables tagging the content with specific conditions, such as a geolocation tag.

Memory 155 also stores an artificial intelligence extension module 187 that incorporates artificial intelligence extensions in the virtual reality environment of the user computing device 110 and/or support system 190. For this purpose, various artificial intelligence extensions may be used, such as advanced voice command and natural language interface (e.g. Alexa). Artificial intelligence also allows for the ability to provide additional interactions with digital representations of the deceased via chat, text, voice, and the like. For example, both a voice and an avatar may be “skinned” to create a three-dimensional digital representation of the deceased as an avatar. VR applications (apps) include 1) Illness Education—examples include a treatment center tour, education modules on medical treatments, medical devices or illness, 2) Coping—instrumental activities (action-oriented, art, music), intuitive activities (thoughtfulness, meditation and breathing), and 3) Legacy Building (memories, quests, photo, video, anticipatory grief activities (virtual memory box)).

FIG. 9 shows a representative support system 190 wherein the above described modules 172-189 are stored as modules 172′-189′ in memory 155′ of the server 130 of support system 190. Like numbers indicate like elements when comparing server 130 of FIG. 9 with user computing device 110 of FIG. 8. In the preferred embodiment of FIG. 9, server 130 stores the virtual environment of each user of user computing device 110 and/or the virtual environments of multiple users of multiple user computing devices 110. In this manner, server 130 handles the computing load of modules 172′-189′ rather than user computing device 100 which in some embodiments is a portable computing device that may not provide a large amount of computing capability in terms of millions of instructions per second (MIPS). As seen in FIG. 9, support system 190 includes a database 120 that stores data to be provided to the users of user computing device(s) 110 over network 140.

The following is a list of some terms employed herein. Sample Data Stores: User information (demographic, personally ID, account); Patient Information (activities assigned and completed, quests, locked/unlocked status of various items, setting); Client Information (legacy building photos, storyboards, archives, videos, quests, condition-specific items); Therapist (user information, patient list, patient assigned items, patient clinical notes); System Administration (user names, access control, basic system configuration information)

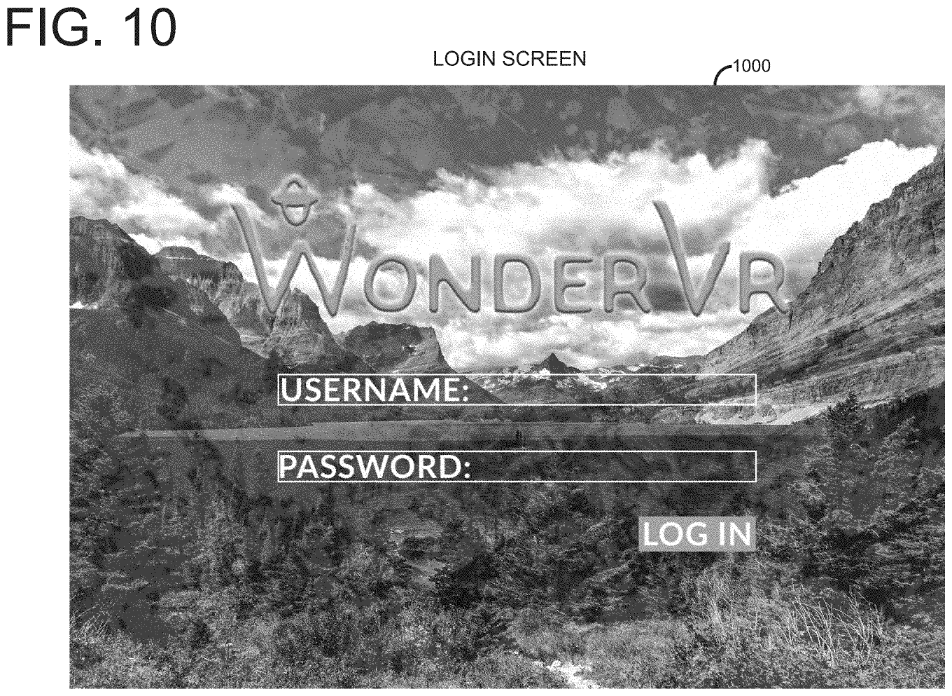

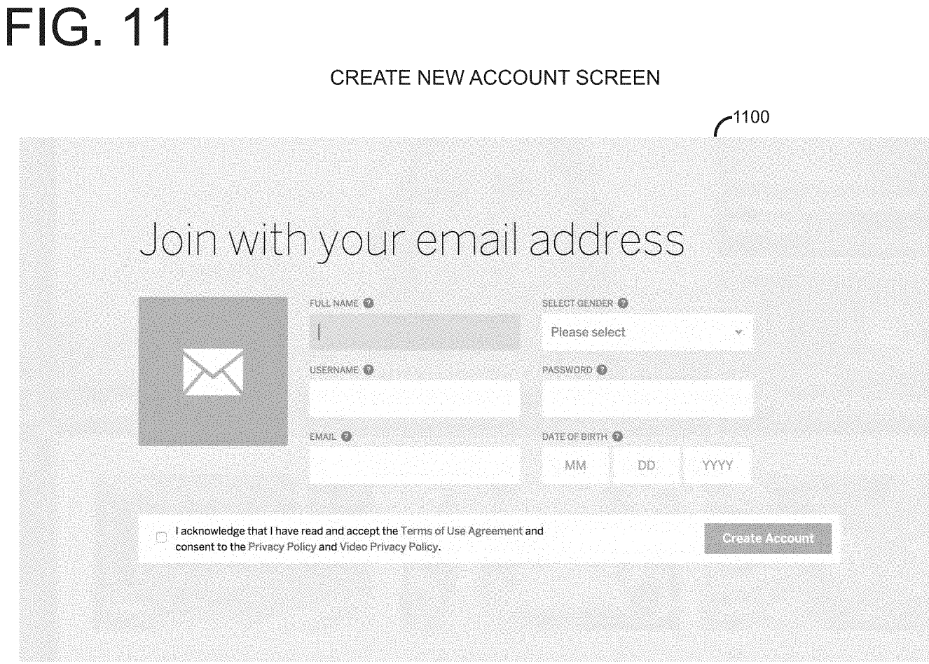

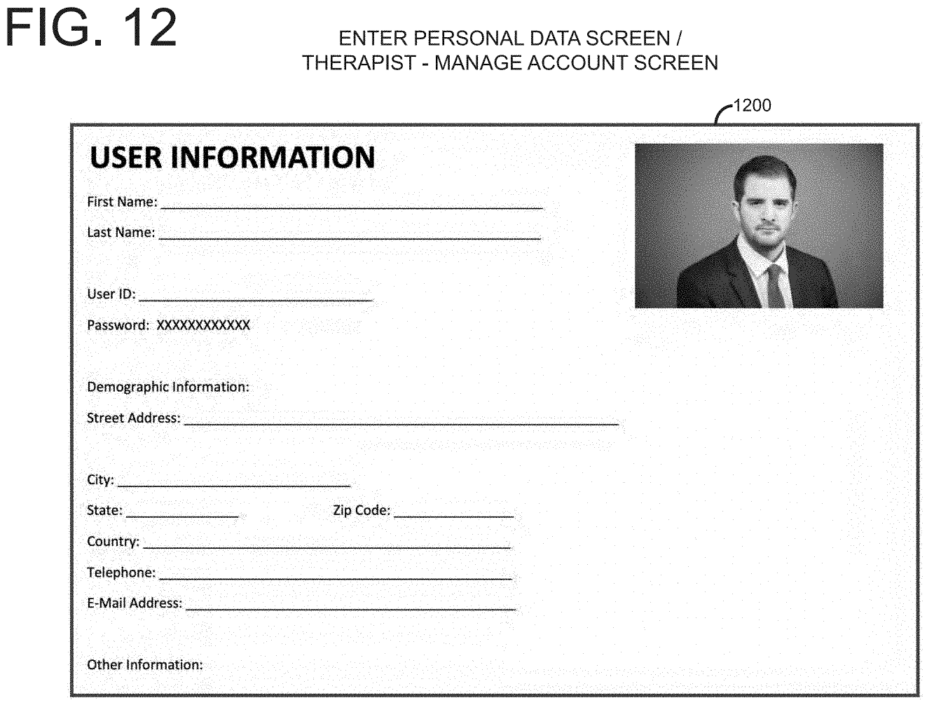

FIG. 10 shows a user login screen 1000 that is presented to a user of who is already active on system 100. Login screen 1000 asks the user to input the user's username and associated password. FIG. 11 provides an alternative login screen 1100 for a new user of system 100 wherein a new user account is created and/or used for the first time by the user. Login screen 1100 allows the new user to input their full name, username, email address, gender, password and date of birth. FIG. 12 depicts a representative enter personal data screen and manage account screen 1200 wherein a therapist user creates an account or updates an existing user account. In one embodiment, screen 1200 may be generated by therapist module 174′. The user of screen 1200 may be a therapist user or other user inputs the following data to create or update a user account with user information, namely first name, last name, user ID, password, street address, city, state, zip code, country, telephone number and email address, as well as other user information and notes.

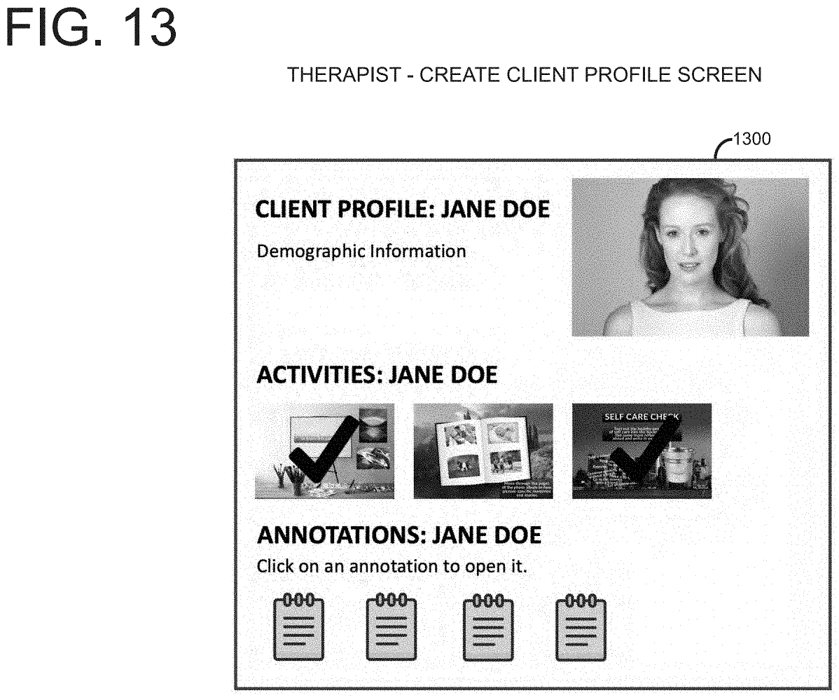

FIG. 13 is a create client profile screen 1300 wherein a therapist user or other user creates a profile for a patient user or client user by naming the patient user or client user and selecting activities for the patient user or client user. To facilitate this selection of activities, the therapist or other user is presented with graphic representations of a number of activities that may be selected. To indicate the selection of an activity for a particular patient user or client user, the therapist or other users places a checkbox in each activity as seen in FIG. 13. The therapist user or other user may input annotations to the client profile as indicated in FIG. 13. In one embodiment, the create client profile screen 1300 is generated by therapist module 174′.

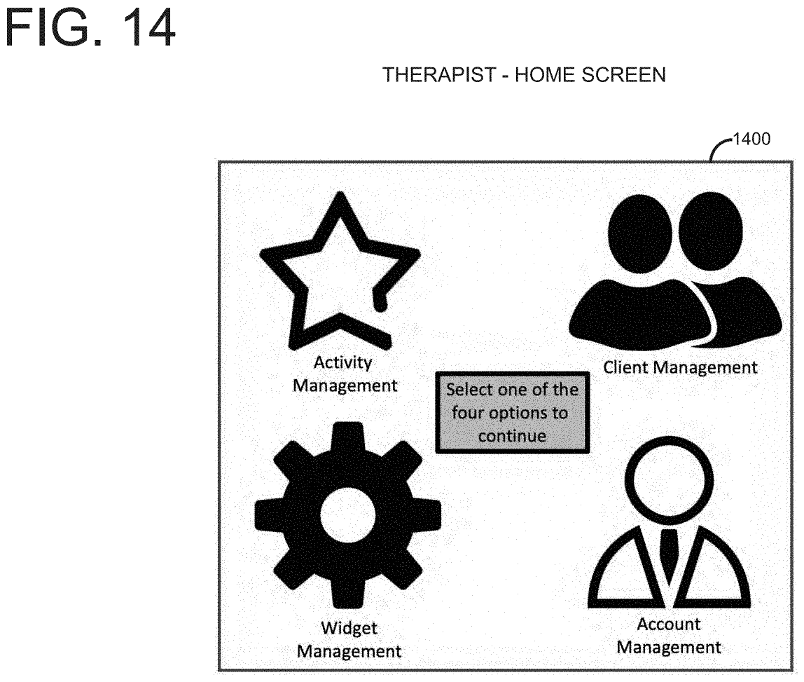

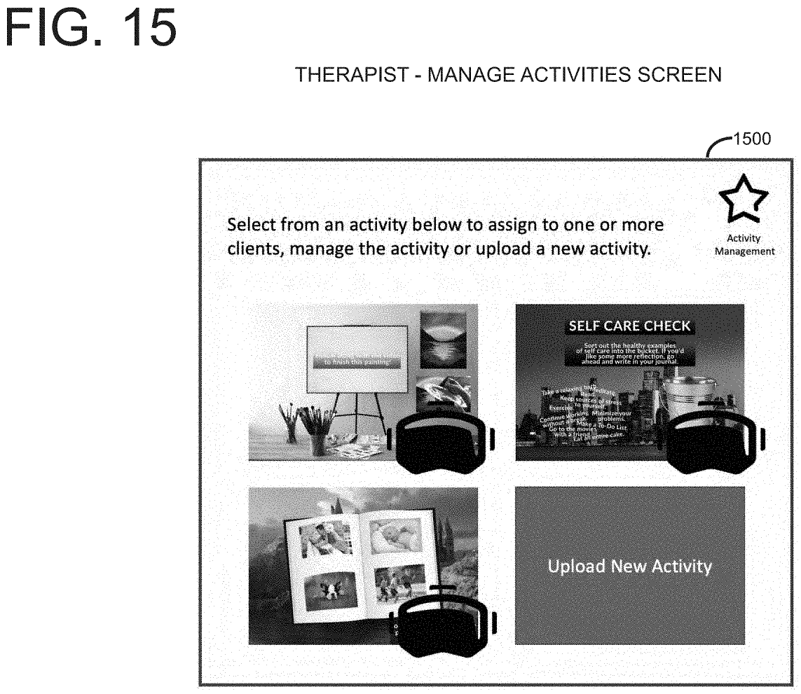

FIG. 14 shows a therapist home screen 1400 wherein a therapist user or other user can select one of four functions to continue, namely activity management to manage activities, client management, widget management and account management. When a therapist or other user selects “activity management” on therapist home screen 1400, activities module 180 is accessed to generate “therapist—manage activities” screen 1500 as shown in FIG. 15. Screen 1500 includes three VR environment activities for the therapist or other user to select as indicated by the VR headset icon in the lower right corner of each depicted activity. Alternatively, the therapist or other user may select “Upload New Activity” to upload a new activity to the collection of activities available on system 100.

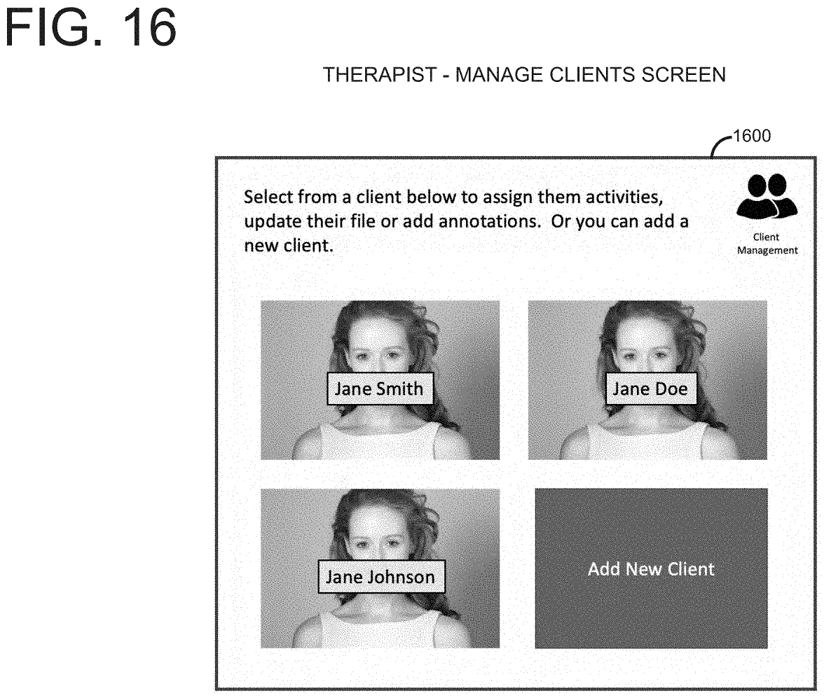

FIG. 16 shows a “therapist—manage clients” screen 1600 that the therapist or other user may access to manage clients. For example, screen 1600 includes images for three representative clients Jane Smith, Jane doe and Jane Johnson that may be selected to manage their respective activities. Screen 1600 invites the user to select a particular client to be assigned with selected activities, or to update their file, or to add annotations. Screen 1600 also allows the user to select “add a new client” to input a new client to system 100 for storage in database 120. To perform the operations described above, system 100 may employ therapist module 174 and/or client administration module 176.

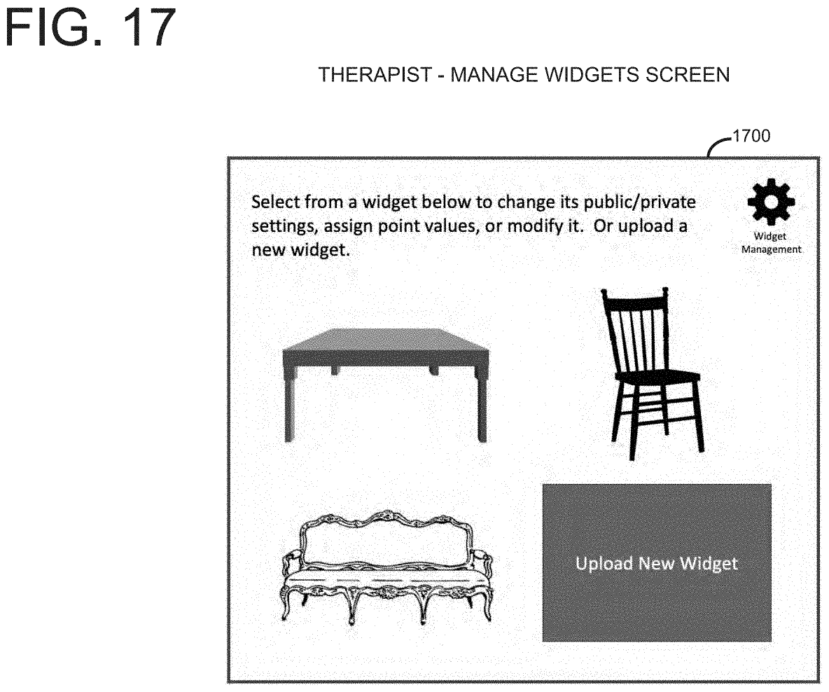

FIG. 17 shows a “therapist—manage widgets” screen 1700 that the therapist or other user may use to select one or more widgets for use by the patient user or client user. In this particular example, the table represents an X widget, the chair represents a Y widget and sofa represents a Z widget. Screen 1700 allows the user to “select from a widget below to change its public/private settings, assign point values” for tasks completed, or to modify the widget. In one embodiment, system 100 accesses widget module 181 to provide the above-described features. A widget is a preconfigured item that exists to support rapid deployment in the system. So rather than design and upload their own fully customized chair, sofa or table users of the system could make use of a pre-designed sofa widget, chair widget, or table widget.

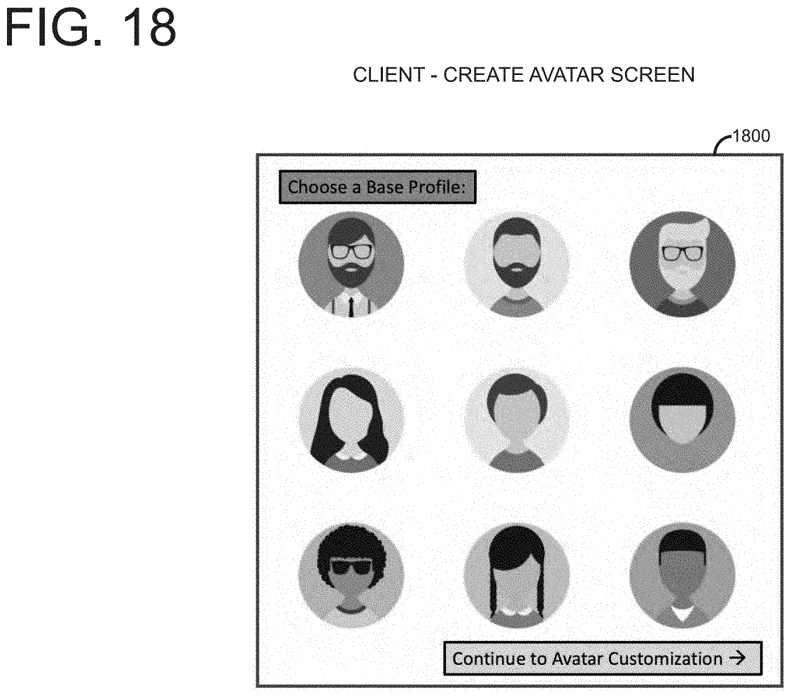

FIG. 18 shows a “client—create avatar” screen 1800 that the client user may use to create or select an avatar to be associated with the particular client. The client may select a base profile indicated by the 9 pictorial representations in screen 1800. Screen 1800 allows the client user to select “continue to avatar customization” to create a custom avatar to be associated with that particular client in database 120. In one embodiment, system 100 accesses client administration module 176 to provide the above-described features.

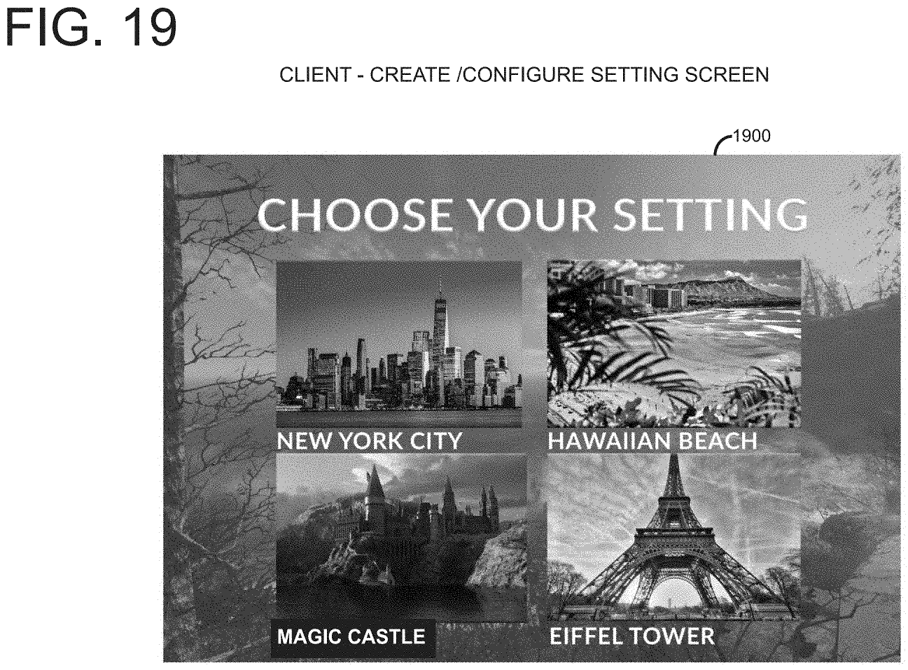

FIG. 19 shows a “client—create/configure setting” screen 1900 that client user may use to select a setting to form part of the VR environment in one embodiment. In this particular example, the client user may select from the following representative settings: New York City, Hawaiian Beach, Magic Castle and the Eiffel Tower as illustrated. In one embodiment, system 100 accesses VR environment initial build module 178 to provide the above-described features.

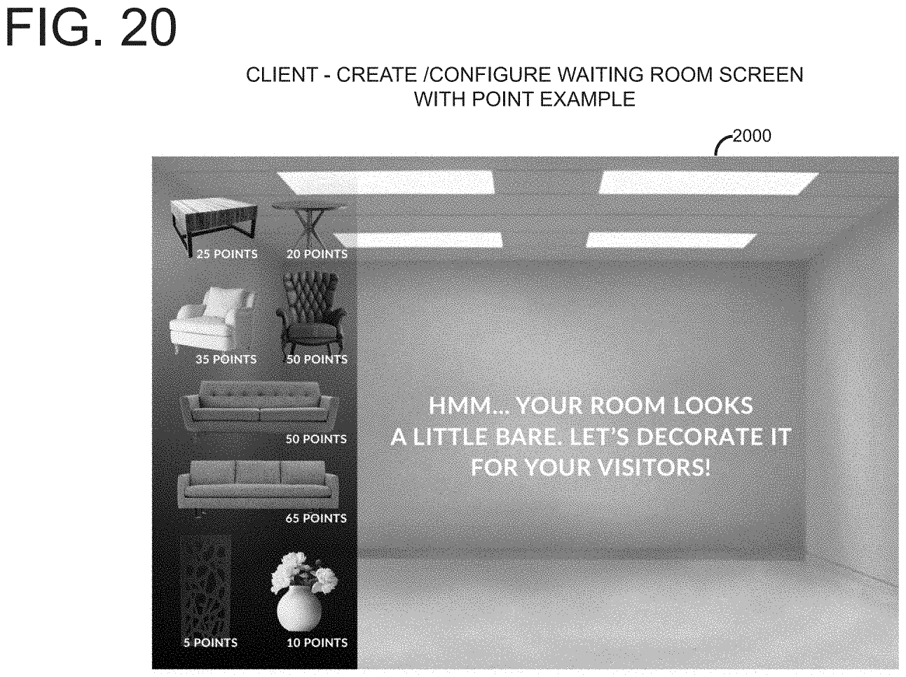

FIG. 20 shows a “client—create/configure waiting room” screen 2000 with point examples. In this screen 2000, the client user may select one or more furnishings of the waiting room. Each time the client user selects a furnishing, the user receives a number of points as indicated in FIG. 20. For example, 50 points may be awarded the user for selection of a high back chair and 65 points may be awarded the user for selection of a large sofa, while a lower amount of 10 points may be awarded for selection of a vase with flowers. In one embodiment, system 100 accesses VR environment initial build module 178 to provide the above-described features.

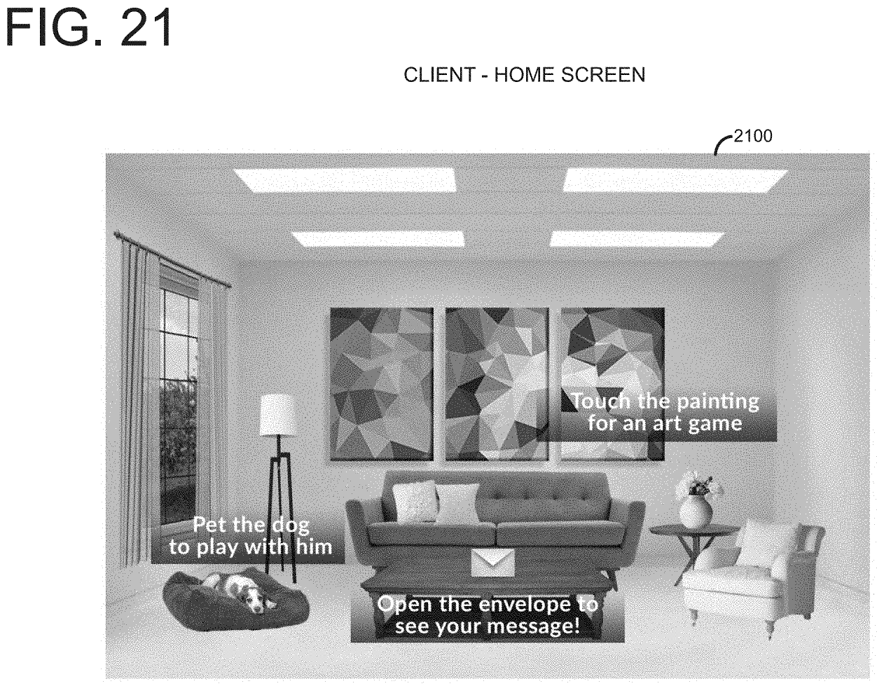

FIG. 21 shows a “client—home screen” 2100 that is presented to the client after login to system 100. In screen 2100, the user can select from multiple activities such as: pet the dog to play with him, open the envelope to see your message!, and touch the painting for an art game, all of these being presented to the user in virtual reality via VR display 112. In one embodiment, system 100 accesses activities module 180 to provide the above-described features.

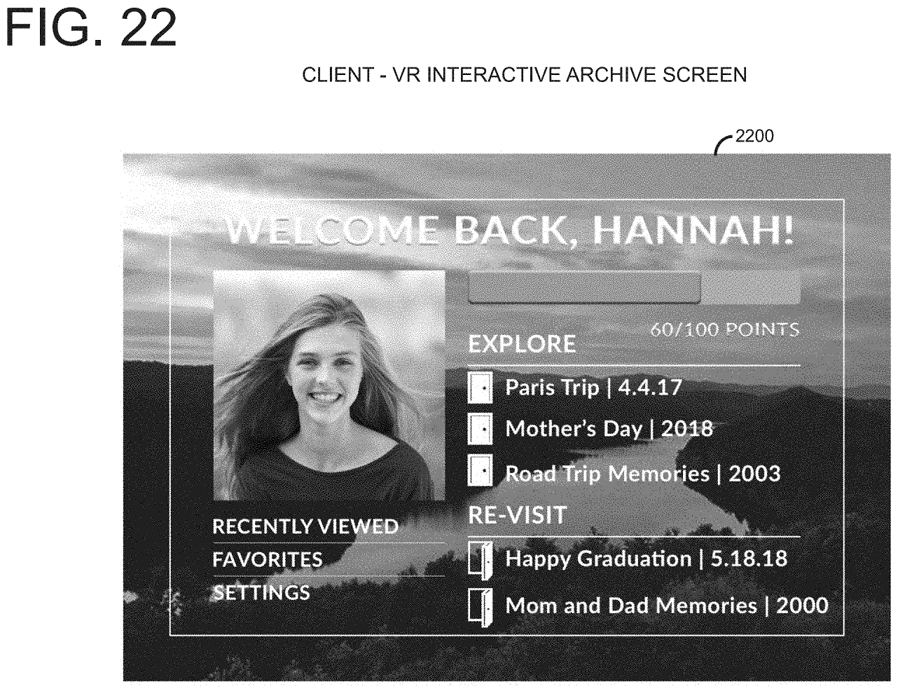

FIG. 22 shows a “VR interactive archive screen” 2200 that is displayed to the user subsequent to successful login to system 100. In this particular example, screen 2200 welcomes back the particular user after login. For example, screen 2200 greets the returning user by name and displays the user's current point score for participating in activities and quests. Screen 2200 invites the returning client user to explore selections such as Paris Trip, Mother's Day 2018, and Road Trip Memories as part of the virtual interactive archive of this particular user, wherein the virtual interactive archive is stored in database 120. The user is also afforded the opportunity to “revisit” Happy Graduation and to “revisit” Mom and Dad Memories as part of the virtual interactive archive. The user may also select “recently viewed” content, favorites as well is settings of the VR interactive archive. In one embodiment, system 100 accesses VR interactive archive build/update/display module 179 to provide the above-described features.

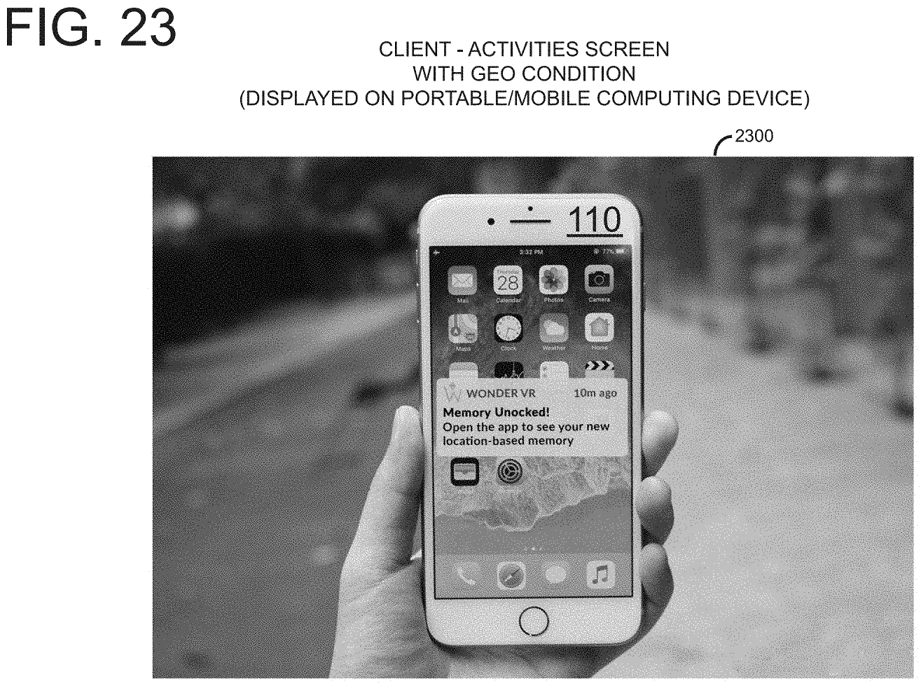

FIG. 23 shows a “Client—Activities with Geo-condition” screen 2300 as displayed on a portable/mobile user computing device 100. In this particular example, system 100 displays the message “Memory Unlocked—Open the app to see your new location based memory” when the condition of the user being located at a particular geographic location is met. In other words, as the user of user computing device 110 moves from location to location, system 100 determines the current location of the user by monitoring GPS 166 in user computing device 110. In one embodiment, user computing device 110 offers to create a new memory at the current particular location or to add to or update a previously stored memory. While performing an activity, system 100 may detect that the user is currently at a particular location and offers the user an opportunity to create a memory involving that location. In one embodiment, system 100 accesses GPS module 189 and activities module 180 to provide the above-described features.

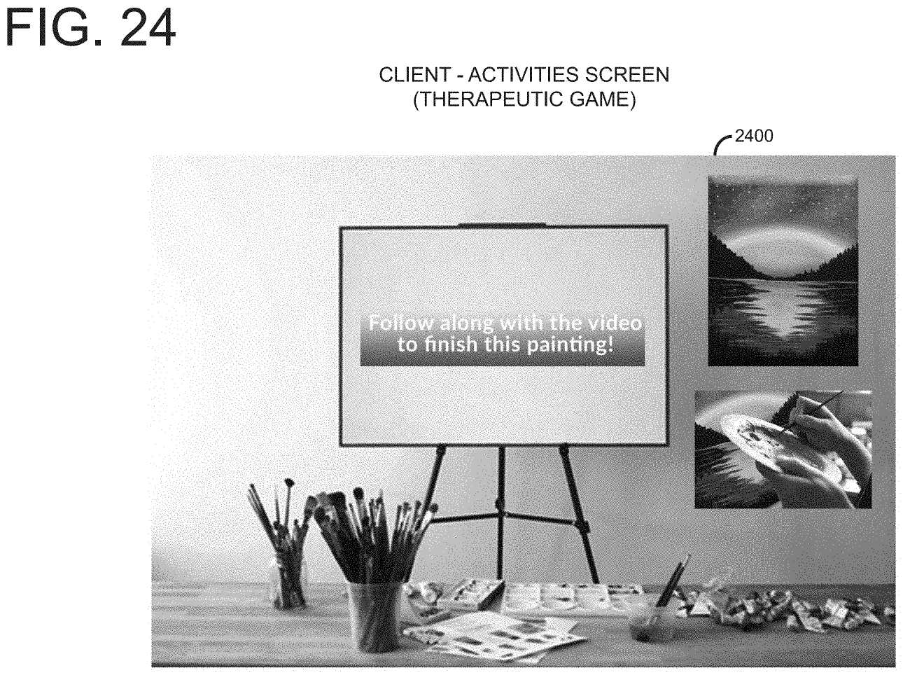

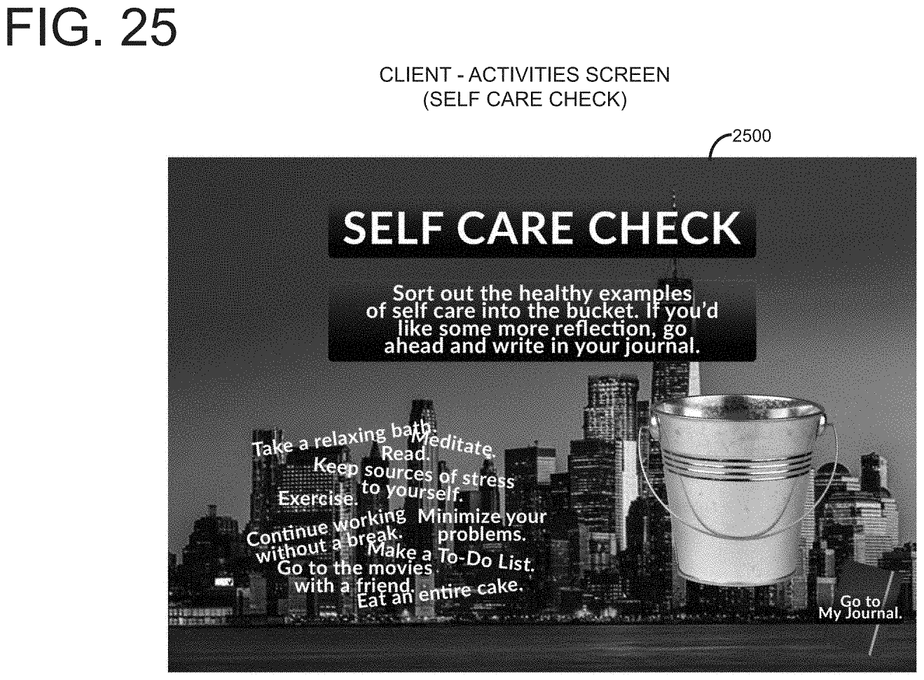

FIG. 24 shows a “Client—Activities” screen 2400 that provides a therapeutic game to the user of client computing device 110. In this particular example, a video is presented to the patient user or client user of client computing device 110. The user is given the opportunity to participate in the activity of following along with the video to finish this painting with all being presented on VR on VR headset 112. In one embodiment, system 100 accesses activities module 180 to provide the above-described features. FIG. 25 shows a “Client—Activities Screen (Self Care Check) screen 2500. In this activity example, the user can participate in a self care health care check activity by sorting through the options suggested in the lower left of screen 2500. In this self care check activity, the user places healthy options in the bucket and leaves other options still in the lower left of screen 2500. For example, the user may move the “take a relaxing bath”, “exercise” and “read” options into the bucket as being healthy options, while leaving the “eat an entire cake” and the “continue working without a break” options still in the lower left corner as being unhealthy options. In one embodiment, system 100 accesses activities module 180 to provide the above-described features.

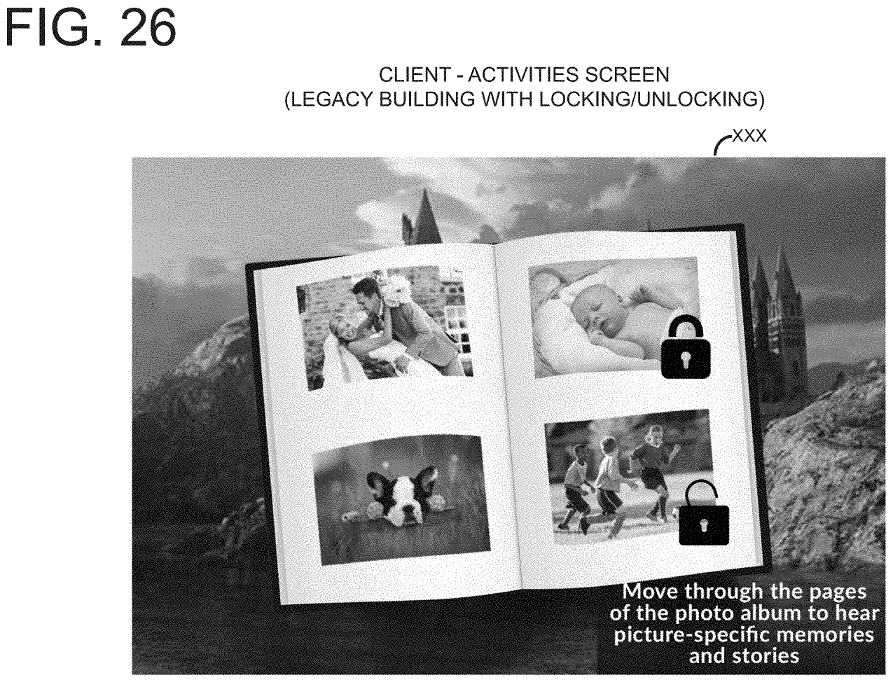

FIG. 26 shows a “Client-Activities” screen 2500 that provides legacy building with content locking/unlocking. In this example, a virtual photo album is displayed to the user of user computing device 110. The user is encouraged to move through the pages of the virtual photo album to hear picture-specific memories and stories as part of the interactive archive stored in database 120. In the photo album some pictures are locked as indicated by the lock symbol on those photos, while other pictures are unlocked as indicated by the unlocked symbol on those photos. In one embodiment, system 100 accesses activities module 180 to provide the above-described features.

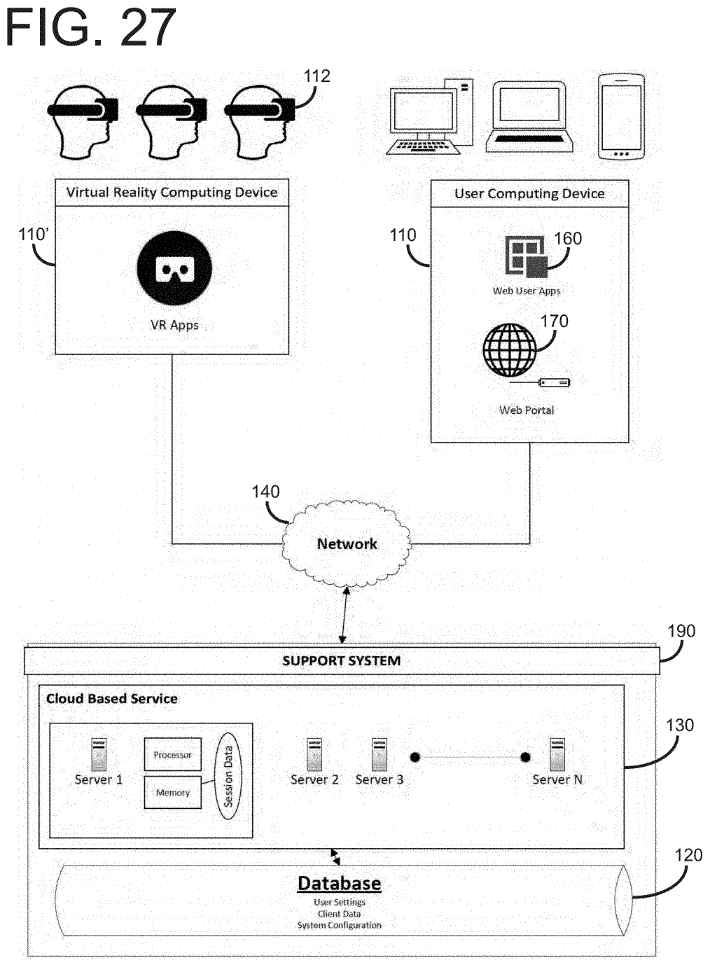

FIG. 27 shows an embodiment of system 100 that includes a user computing device 110, a virtual reality (VR) computing device 110′ that are both coupled to support system 190 via network 140. User computing device 110 incorporates web user apps 160 and a web portal 170 for accessing network 140 such as the Internet. VR computing device 110′ includes VR apps as shown. In this particular embodiment support system 190 includes servers 190, namely Server 1, Server 2, . . . Server N, wherein N is the total number of servers. Servers 1-Server N are coupled to a database 130 that may be implemented as network attached storage. Database 120 stores user settings, client data and systems configuration information.

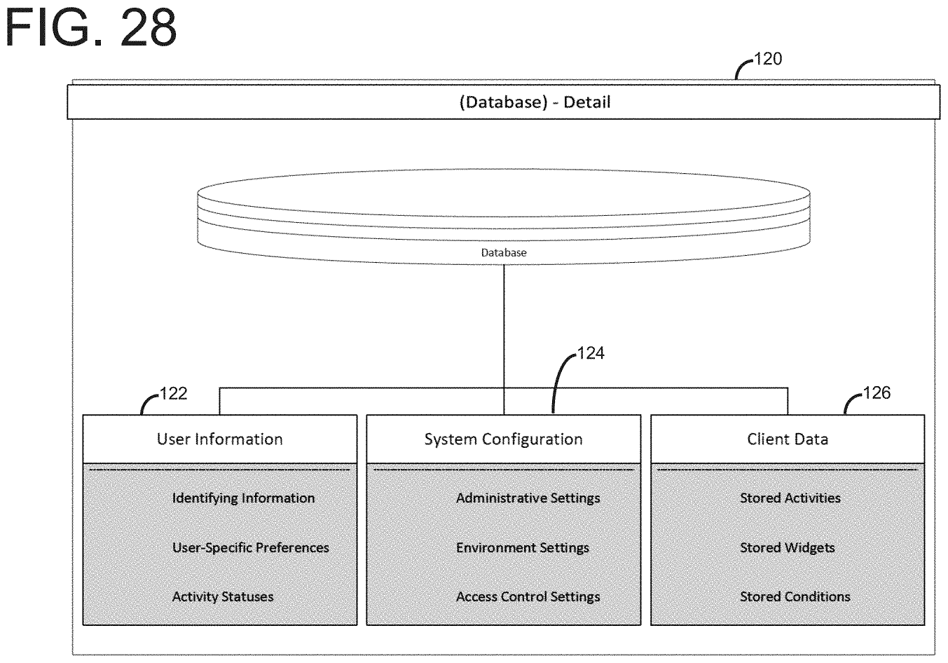

FIG. 28 is a representation of database 120 that resides in support system 180. Database 120 stores user information 122 such as user identification information, user specific preferences and activity status. The current activity status of a user can indicate the percentage completion of a particular activity or quest. Database 120 also stores system configuration information 124 such as administrative settings, VR environment settings and access control settings. Database 120 further stores client data 126 such as stored activities, stored widgets and stored conditions.

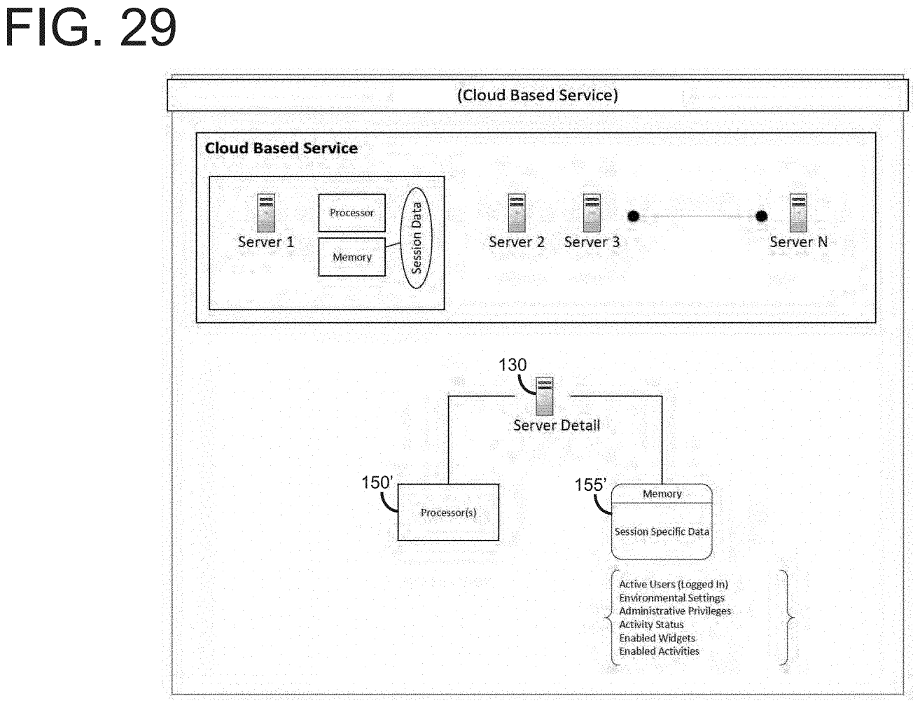

FIG. 29 is a representation of a cloud based service that provides provisioning of servers to perform the computing operations described herein. These provisioned servers, namely Server 1, Server 2, . . . Server N effectively provide server 130 with processors 150′ and memory 155′, as shown. Memory 155′ stores data associated with active users, namely those currently logged in, as well as VR environmental settings, administrative settings, activity status, enabled widgets and enabled activities.

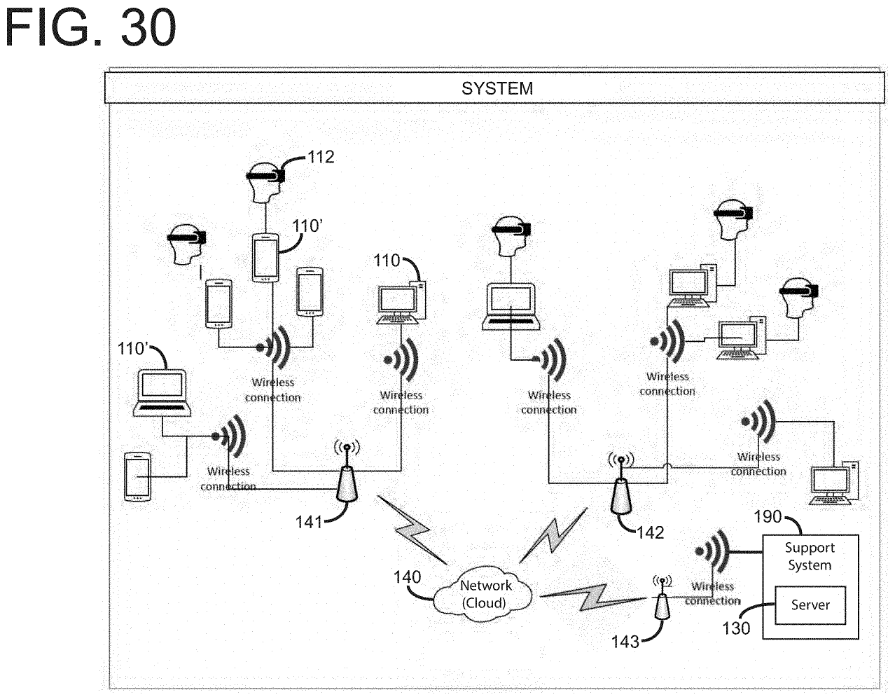

FIG. 30 shows an embodiment of system 100 that is formed by multiple user computing devices 110 and 110′ coupled together and to support system 190 via wireless access points 141, 142 and 143. In this particular embodiment, user computing devices 110 are those user computing devices that are at fixed locations, such as a desktop system. User computing devices 110′ are those user computing devices that are portable or mobile. Some mobile user computing devices may employ a VR headset 112 as shown. Ultimately, network 140 couples all user computing devices 110, 110′ and support system 190 with its server 130 together.

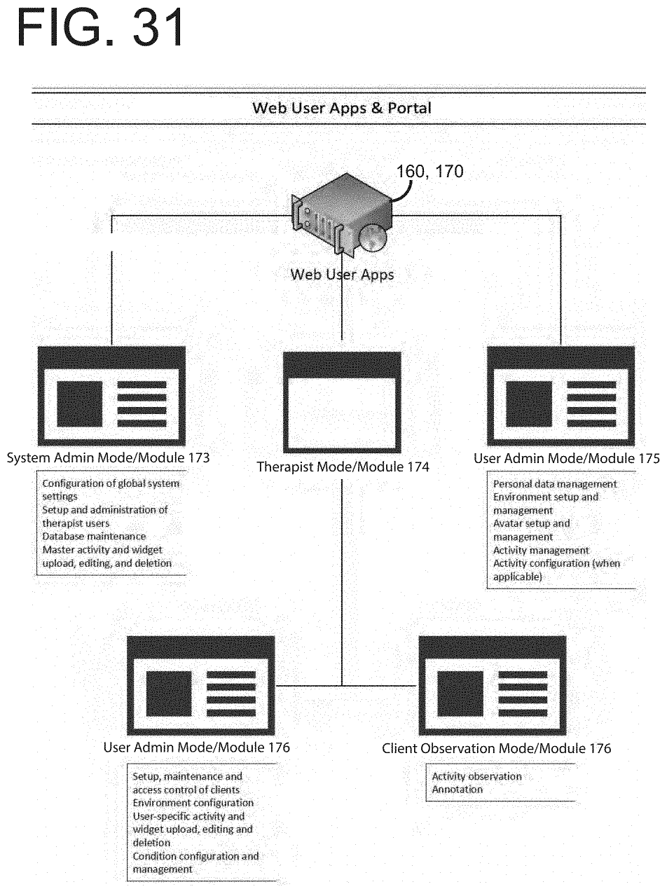

FIG. 31 illustrates system administration mode/module 173, therapist mode/module 174, user administration mode/module 175, user administration module 176 and client observation mode/module 176. The modules are identified in FIGS. 8 and 9 above. System administration module 173 provides configuration of global settings, setup administration of therapist users, database maintenance, as well as master activity and widget upload, editing and deletion. User administration module 175 provides personal data management, VR environment setup and management, avatar setup and management, and activity configuration (when applicable). User administration module 176 provides setup, maintenance and access control of clients, VR environment configuration, user-specific activity and widget upload, editing and deletion, as well as condition configuration and management. Client observation module 176 provides for activity observation by the therapist or other user of the patient or client. Client observation module 176 also provides the therapist with the ability to annotate the observations.

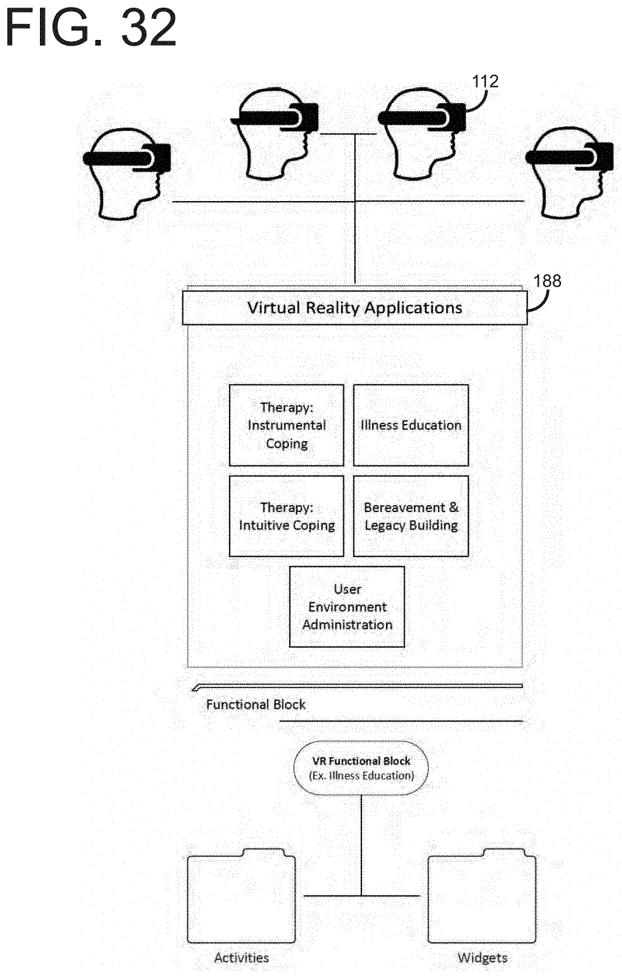

FIG. 32 show examples of representative virtual reality (VR applications 188 that user computing device 110 and/or support system 190 stores. The VR environment is best experienced by using a VR display such as VR headset 112 as shown. Representative VR applications include therapy-instrumental coping, illness education, therapy-intuitive coping, bereavement and legacy building. The VR apps may also include a user VR environment administration application. Each VR application may include both activities and widgets as seen in the VR functional block portion of FIG. 32.

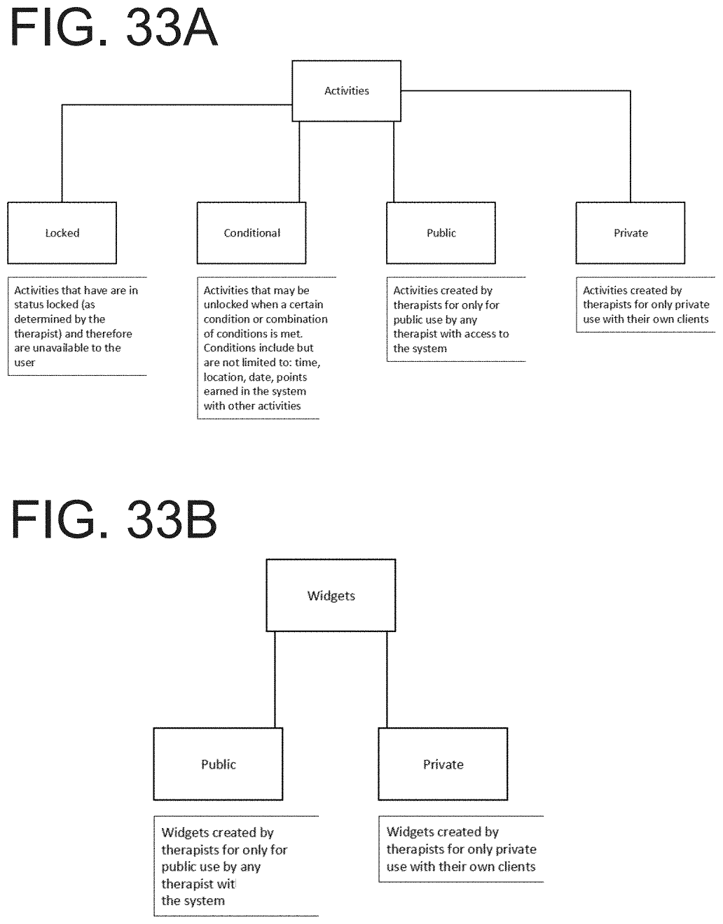

FIG. 33A shows a representation of activities and characteristics of activities such as locked/unlocked activities, conditional activities, public activities and private activities. Activities may exhibit a locked or unlocked status that determines if a particular user is allowed to access a particular activity. Activities that exhibit a locked status, as determined by a therapist with respect to a particular user, are not available to that user. Conditional activities are activities that may be unlocked when a certain condition or combination of conditions is met. Such conditions include, but are not limited to time, location, date, and points earned in the system with other activities. Public activities are those activities created by therapists only public use by any therapist with access to the system. Private activities are activities created by therapists for only private use with their own clients. FIG. 33B shows a representation of widgets as public widgets and private widgets. Public widgets are those widgets created by therapists only for public use by any therapist on the system. Private widgets are those widgets created by therapists for only private use with their own clients.

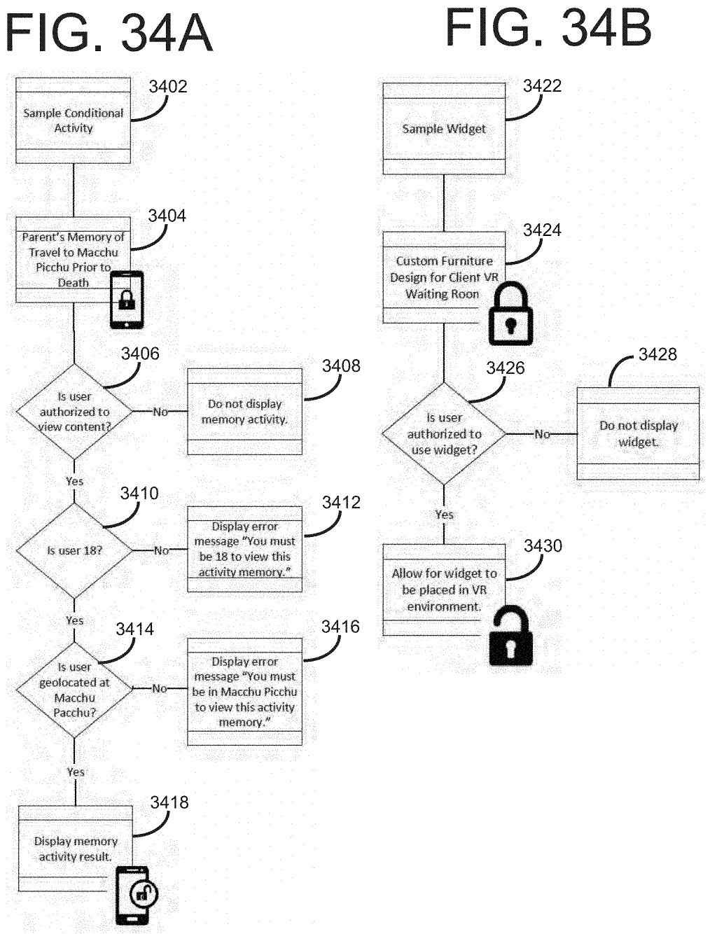

FIG. 34A is a flowchart that describes a representative process flow for activities. Process flow commences at sample conditional activity, as per block 3402. The particular activity being conducted concerns a parent's memory of travel to Machu Picchu prior to death. This activity may be either locked or unlocked for a particular user as indicated by the present or absence, respectively, of a lock icon on block 3404. Decision block 3406 conducts a test to determine if the particular user is authorized to view this particular content. If the user is not authorized, then process flow continues to block 3408 and the user is not allowed access to this content. However, if decision block 3406 determines that the user is authorized to view that content, access is granted to the user. The above authorization of a particular user to access particular content is an example of a condition. Another condition is tested at decision block 3410, namely the age of the user. In this example, if the user is not over 18, then the user is not allowed to access the content and the message “You must be 18 to view this activity memory” is displayed to the user. However, if the user is 18, then process flow continues to decision block 3414. Decision block 3414 performs a test to determine if the user is currently located at Machu Picchu. If the user is not currently located at Machu Picchu, then the user computing device 110 displays the message, “You must be located at Machu Picchu to view this activity memory”. However, if the user is currently located at Machu Picchu, then user computing device 110 displays the memory activity result, as per block 3418.

FIG. 34B is a flowchart that describes a representative process flow for widgets. Process flow commences at sample widget block 3502. A custom furniture design for a particular client is displayed in the client's VR waiting room, as per block 3424. A test is performed at decision block 3426 to determine is this client user is authorized to use the widget, i.e. to use the custom furniture. If the client user is not authorized to use the widget, then the widget is not displayed, as per block 3428. However, if the client user is authorized to use the widget, then the system allows the client user to place the widget in the client users' VR environment, as per block 3430.

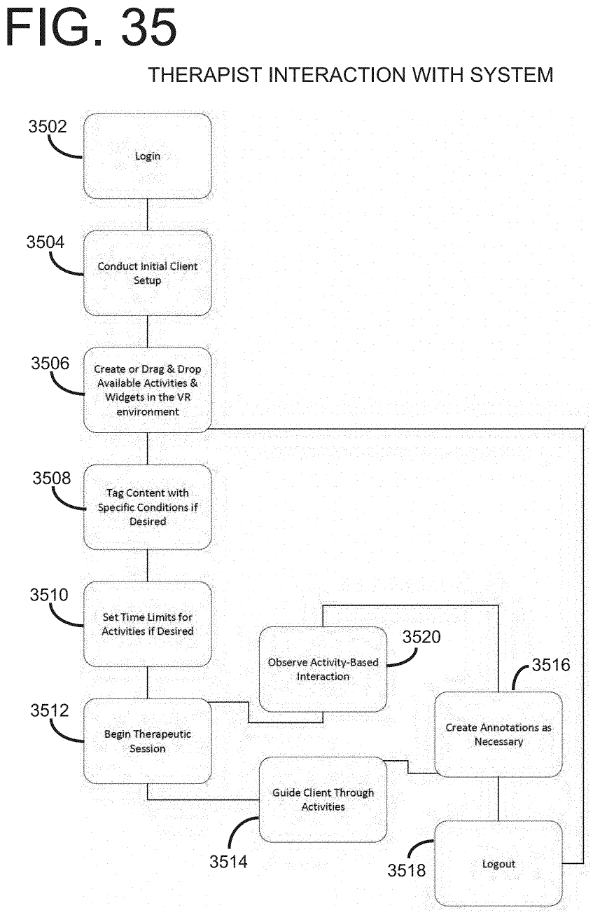

FIG. 35 is a flowchart that depicts a therapist's typical interaction with the system. The therapist logs in, as per block 3502, and initial client setup is conducted, as per block 3504. The therapist user creates or drags and drops available activities and widgets in the VR environment, as per block 3506. Content is tagged with specific conditions desired by the therapist, as per block 3508. The therapist sets time limits for activities if desired, as per block 3510. A representative therapeutic session begins at block 3512. At this point, the therapist may observe an activity-based interaction by the client user, as per block 3520. The therapist user may create an annotation associated with this activity and user, as per block 3516. Next, the therapist logs out, as per block 3518. After therapeutic session begins at block 3512, the therapist may alliteratively guide the client through activities, as per block 3514. Next, the therapist logs out, as per block 3518.

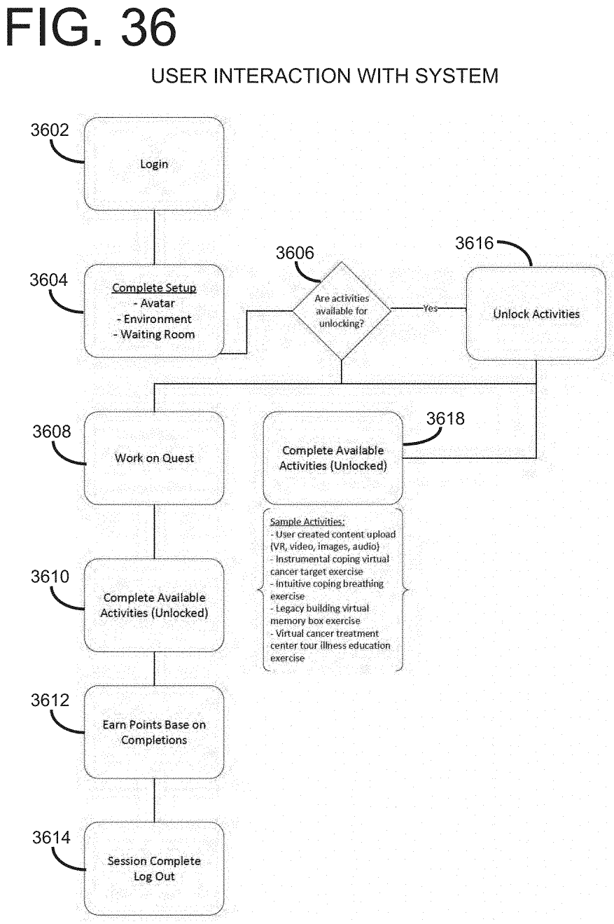

FIG. 36 is a flowchart that depicts a patient user's or client user's typical interaction with the system. The user logs in, as per block 3602. The user competes setup by selecting an avatar, a VR environment and a VR waiting room, as per block 3064. A test is conducted a decision block 3606 to determine if activities are available for unlocking. If activities are not available for unlocking, then the user may work on a quest, as per block 3608. The user completes any available unlocked activities, as per block 3610. The user earns points based on completion of activities, as per block 3612. Next, the user logs out, as per block 3614. Alternatively, if at decision block 3606 it is determined that an activity may be unlocked for the particular user, then such activity is unlocked as per block 3616. Process flow then continues to complete available activities block 3618. Representative activities that system 100 may employ include user created content uploads (such as VR, video, images and audio), instrumental coping virtual cancer target exercises, intuitive coping breathing exercises, legacy building virtual memory box exercises, and virtual cancer treatment center tour illness education center exercises.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Process steps may be performed in an order different than those presented for purposes of example Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. (canceled)

2. A method for creating VR-based interactive archives, comprising:
accessing, by a user information handling system (IHS), a support system of a server IHS via a communication network between the user IHS and the server IHS, wherein the accessing is directed to a user account unique to a user of the user IHS,
constructing, by the user, a user-specific virtual reality environment in the support system by selecting a setting from a plurality of predetermined settings;
displaying, by the user IHS to the user, an initial user-specific virtual reality environment corresponding to the user selected setting;
building a room environment within the initial user-specific virtual reality environment by dragging and dropping selectable items into the room environment to form a modified user-specific virtual reality environment;
creating content, or dragging-and-dropping forms of choosable predetermined content, in the modified user-specific virtual reality environment to form an altered user-specific virtual reality environment that includes selected content, and if the selected content in the support system is associated with a specific condition, then tagging the content with specific conditions;
displaying, by the user IHS to the user, the altered user-specific virtual reality environment; and
storing, in an information store, the altered user-specific virtual reality environment as a VR-based interactive archive.

3. The method of claim 2, wherein the plurality of predetermined settings includes geographic locales.

4. The method of claim 2, wherein the items comprise room furnishings that include one or more of couches, chairs, vases and tables.

5. The method of claim 2, wherein the content includes one or more of virtual reality images, video images, pictures and audio.

6. The method of claim 2, wherein the specific condition is a real-world geolocation tag.

7. The method of claim 2, wherein the altered user-specific virtual reality environment includes dependency controls that set time limits on user activities in the altered user-specific virtual reality environment.

8. The method of claim 2, wherein the altered user-specific virtual reality environment includes virtual reality extensions.

9. The method of claim 2, wherein the altered user-specific virtual reality environment includes one or more configurable quests for users to discover family history information.

10. The method of claim 2, wherein the first and second displaying steps employ a virtual reality display for observation by a user.

11. The method of claim 2, wherein the altered user-specific virtual reality environment includes a plurality of activities in which a user may selectably participate.

12. A user information handling system (IHS), comprising
a processor;
a virtual reality display coupled to the processor;
a memory store coupled to the processor, the memory store being configured to:
access a support system of a server IHS via a communication network between the user IHS and the server IHS, wherein the accessing is directed to a user account unique to a user of the user IHS,
construct, by the user, a user-specific virtual reality environment in the support system by selecting a setting from a plurality of predetermined settings;
display, by the virtual reality display of the user IHS, an initial user-specific virtual reality environment corresponding to the user selected setting;
build a room environment within the initial user-specific virtual reality environment by dragging and dropping selectable items into the room environment to form a modified user-specific virtual reality environment;
create content, or dragging-and-dropping forms of choosable predetermined content, in the modified user-specific virtual reality environment to form an altered user-specific virtual reality environment that includes selected content, and if the selected content in the support system is associated with a specific condition, then tagging the content with specific conditions;
display, by the virtual reality display of the user IHS, the altered user-specific virtual reality environment; and
store, in an information store, the altered user-specific virtual reality environment as a VR-based interactive archive.

13. The user information handling system (IHS) of claim 12, wherein the plurality of predetermined settings includes geographic locales.

14. The user information handling system (IHS) of claim 12, wherein the items comprise room furnishings that include one or more of couches, chairs, vases and tables.

15. The user information handling system (IHS) of claim 12, wherein the content includes one or more of virtual reality images, video images, pictures and audio.

16. The user information handling system (IHS) of claim 12, wherein the specific condition is a real-world geolocation tag.

17. The user information handling system (IHS) of claim 12, wherein the altered user-specific virtual reality environment includes dependency controls that set time limits on user activities in the altered user-specific virtual reality environment.

18. The user information handling system (IHS) of claim 12, wherein the altered user-specific virtual reality environment includes virtual reality extensions.

19. The user information handling system (IHS) of claim 12, wherein the altered user-specific virtual reality environment includes one or more configurable quests for users to discover family history information.

20. The user information handling system (IHS) of claim 12, wherein the altered user-specific virtual reality environment includes a plurality of activities in which a user may selectably participate.
